(19) United States
(12) Patent Application Publication
(10) Pub. No.: US 2015/0168798 A1
(43) Pub. Date: Jun. 18, 2015

(54) RECORDING MEDIUM AND IMAGE RECORDING SET

(71) Applicants: Daiki Yamashita, Tokyo (JP); Nozomu Tamoto, Shizuoka (JP)

(72) Inventors: Daiki Yamashita, Tokyo (JP); Nozomu Tamoto, Shizuoka (JP)

(73) Assignee: RICOH COMPANY, LTD., Tokyo (JP)

(21) Appl. No.: 14/561,376

(22) Filed: Dec. 5, 2014

(30) Foreign Application Priority Data
Dec. 13, 2013 (JP) 2013-258334

(51) Int. Cl. G02F 1/167

(52) U.S. Cl. CPC G02F 1/167

(57) ABSTRACT

A recording medium includes a first substrate, a second substrate, and an image recording layer with insulating properties, provided between the first substrate and the second substrate. The image recording layer includes cells each encapsulating at least one of electrophoretic particles or magnetophoretic particles having two or more colors, a dispersion medium, and a thermoreversible gelling agent. At least one of the sol transition temperature or the gel transition temperature of the dispersion medium in each cell is different depending on the combination of the two or more colors of the at least one of the electrophoretic particles or magnetophoretic particles in each cell.

### CROSS-REFERENCE TO RELATED APPLICATIONS

This patent application is based on and claims priority pursuant to 35 U.S.C. 119(a) to Japanese Patent Application No. 2013-258334, filed on Dec. 13, 2013, in the Japan Patent Office, the entire disclosure of which is hereby incorporated by reference herein.

### BACKGROUND

1. Technical Field

The present invention relates to a recording medium and an image recording set.

2. Background Art

Electronic paper, which is thin, lightweight, requiring no backlight and less power consumption, visible and portable like paper material, has been put into practical use and gained attention. Electronic paper is classified into internally-driven type paper-like display (hereinafter referred to as PLD) that includes a drive element inside to display images by itself and externally-driven type rewritable paper on which images are written on a recording medium on by a printer. The rewritable paper includes general recording media such as repeatedly rewritable paper or sheets.

Various systems of electronic paper have been proposed. Of these, an electrophoretic system, that conducts display by changing an optical reflectance by migrating charged white and/or colored particles in a liquid to the surface side or the opposite direction of a display medium by an electric field is known as the most practical system. Above all, microcapsule type electrophoretic system is already practically used as electronic paper and gains much attention.

### SUMMARY

The present invention provides an improved recording medium including a first substrate, a second substrate, and an image recording layer with insulating properties, provided between the first substrate and the second substrate, the image recording layer including cells each encapsulating at least one of electrophoretic particles or magnetophoretic particles having two or more colors, a dispersion medium, and a thermoreversible gelling agent, wherein at least one of the sol transition temperature or the gel transition temperature of the dispersion medium in each cell is different depending on the combination of the two or more colors of the at least one of the electrophoretic particles or magnetophoretic particles in each cell.

As another aspect of the present invention, an improved recording medium is provided which includes a first substrate, a second substrate, and an image recording layer with insulating properties, provided between the first substrate and the second substrate, the image recording layer including cells each encapsulating at least one of electrophoretic particles or magnetophoretic particles, a colorant, a dispersion medium having a color by the colorant, and a thermoreversible gelling agent, wherein the color by the colorant is different from the color of at least one of electrophoretic particles or magnetophoretic particles, wherein at least one of the sol transition temperature or the gel transition temperature of the dispersion medium in each cell is different depending on the color by the colorant.

### BRIEF DESCRIPTION OF THE SEVERAL VIEWS OF THE DRAWINGS

Various other objects, features and attendant advantages of the present invention will be more fully appreciated as the same become better understood from the detailed description when considered in connection with the accompanying drawings, in which like reference characters designate like corresponding parts throughout and wherein

FIG. 1 is diagrams illustrating examples of forms of cells for use in the image recording layer of a recording medium using the cells according to an embodiment of the present invention;

FIG. 2 is a schematic diagram illustrating an example of the recording medium using cells according to an embodiment of the present invention;

FIG. 3 is a schematic diagram illustrating another example of the recording medium using cells according to an embodiment of the present invention;

FIG. 4 is a schematic diagram illustrating an example of the recording medium using microcapsules according to an embodiment of the present invention;

FIG. 5 is a schematic diagram illustrating another example of the recording medium using microcapsules according to an embodiment of the present invention;

FIG. 6 is a schematic diagram illustrating an example where a cross-section of the image recording layer is a substantially circle;

FIG. 7 is a schematic diagram illustrating an example where a cross-section of the image recording layer is a polygon;

FIG. 8 is a schematic diagram illustrating an example of the recording medium in which an electric conductive layer is formed between the image recording layer and the substrate according to an embodiment of the present invention;

FIG. 9 is a schematic diagram illustrating another example of the recording medium in which an electric conductive layer is formed between the image recording layer and the substrate according to an embodiment of the present invention;

FIG. 10 is a schematic diagram illustrating one example of the recording medium which uses an electric conductive substrate according to an embodiment of the present invention;

FIG. 11 is a schematic diagram illustrating another example of the recording medium which uses an electric conductive substrate according to an embodiment of the present invention;

FIG. 12 is a schematic diagram illustrating yet another example of the recording medium in which an electric conductive layer is formed between the image recording layer and the substrate according to an embodiment of the present invention;

FIG. 13 is a schematic diagram illustrating one example of the recording medium in which an electric conductive layer is formed between the image recording layer and an electric conductive substrate according to an embodiment of the present invention;

FIG. 14 is a schematic diagram illustrating an example of a heating device of an image recording device in an example of the image recording set according to an embodiment of the present invention;

FIG. 15 is a schematic diagram illustrating another example of a heating device of an image recording device in an example of the image recording set according to an embodiment of the present invention;

FIG. 16 is a schematic diagram illustrating an example of an electric field application device in an example of an image recording device in the image recording set according to an embodiment of the present invention;

FIG. 17 is a schematic diagram illustrating another example of an electric field application device in an example of an image recording device in the image recording set according to an embodiment of the present invention;

FIG. 18 is a schematic diagram illustrating an example of an image recording device in the image recording set according to an embodiment of the present invention;

FIG. 19 is a schematic diagram illustrating another example of an image recording device in the image recording set according to an embodiment of the present invention;

FIG. 20 is a schematic diagram illustrating another example of an image recording device in the image recording set according to an embodiment of the present invention;

FIG. 21 is a schematic diagram illustrating another example of an image recording device in the image recording set according to an embodiment of the present invention;

FIG. 22 is a schematic diagram illustrating another example of an image recording device in the image recording set according to an embodiment of the present invention;

FIG. 23 is a schematic diagram illustrating another example of an image recording device in the image recording set according to an embodiment of the present invention;

FIG. 24 is a diagram illustrating an example of an image recording set where a recording medium and an image recording device are integrated together;

FIG. 25 is a diagram illustrating another example of an image recording set where a recording medium and an image recording device are integrated together;

FIG. 26 is a diagram illustrating another example of an image recording set where a recording medium and an image recording device are integrated together;

FIG. 27 is a diagram illustrating another example of an image recording set where a recording medium and an image recording device are integrated together; and

FIG. 28 is a diagram illustrating another example of an image recording set where a recording medium and an image recording device are integrated together.

### DETAILED DESCRIPTION

The present invention provides a recording medium that can display not only monochrome but also three or more colors and have high levels of image retention.

Although it is preferable that the recording medium of the present invention is rewritable, meaning that it records and erases images repeatedly, a recording medium having a configuration similar to the present invention with a feature to restrict rewritability by an additional device, unit, etc. is also included.

The present disclosure will be described below in detail with reference to several embodiments and accompanying drawings.

Such embodiments are as follows but the present invention is not limited thereto.

1. A recording medium including a first substrate, a second substrate, and an image recording layer with insulating properties, provided between the first substrate and the second substrate, the image recording layer including cells each encapsulating at least one of electrophoretic particles or magnetophoretic particles having two or more colors, a dispersion medium, and a thermoreversible gelling agent, wherein at least one of the sol transition temperature (solation temperature) or the gel transition temperature (gelation temperature) of the dispersion medium in each cell is different depending on the combination of the two or more colors of the at least one of the electrophoretic particles or magnetophoretic particles in each cell.

2. A recording medium including a first substrate, a second substrate, and an image recording layer with insulating properties, provided between the first substrate and the second substrate, the image recording layer including cells each encapsulating at least one of electrophoretic particles or magnetophoretic particles, a colorant, a dispersion medium having a color by the colorant, and a thermoreversible gelling agent, wherein the color by the colorant is different from the color of at least one of electrophoretic particles or magnetophoretic particles, wherein at least one of the sol transition temperature or the gel transition temperature of the dispersion medium in each cell is different depending on the color by the colorant.

3. The recording medium mentioned in 1 or 2, wherein the kind of at least one of the thermoreversible gelling agent or the dispersion medium contained in each cell depends on the color of at least one of the electrophoretic particles or the magnetophoretic particles.

4. The recording medium mentioned in any one of 1 to 3, wherein the first substrate or the second substrate is electroconductive.

5. The recording medium mentioned in any one of 1 to 4, further including an electroconductive layer provided between the first substrate and the image recording layer or between the second substrate and the image recording layer and an electrode on an exterior of the recording medium, wherein the electroconductive layer and the electrode are electrically connected.

6. The recording medium mentioned in any one of 1 to 5, further including a first electric conductive layer between the first substrate and the image recording layer and a first electrode on an exterior of the recording medium, wherein the second substrate is electroconductive, wherein the first electroconductive layer and the first electrode are electrically connected.

7. The recording medium mentioned in any one of 1 to 6, further including a first electroconductive layer between the first substrate and the image recording layer, further including a second electroconductive layer between the second substrate and the image recording layer, further including a first electrode and a second electrode on exteriors of the recording medium, wherein the first electroconductive layer and the first electrode are electrically connected, wherein the second electroconductive layer and the second electrode are electrically connected.

8. An image recording set including any one of the recording media mentioned above and an image recording device to record images in the recording medium, the image recording device including a heating device to heat the image recording layer in the recording medium and at least one of an electric field application device or a magnetic field application device to generate at least one of an electric field or a magnetic field in the image recording layer.

9. The age recording set mentioned in 8, wherein the heating device is a thermal head.

10. The image recording set mentioned in 8 or 9, further including an image erasing device to erase the image recorded in the recording medium by applying heat and at least one of an electric field or a magnetic field to the recording medium.

Recording Medium

The recording medium of the present disclosure includes a first substrate, a second substrate, and an image recording layer provided between the first substrate and the second substrate, and other optional members. Unlike paper-like display (PLD) of internal-driving type having a drive element inside, which is capable of displaying images alone, this recording medium is an externally driven rewritable recording medium capable of repeatedly recording and erasing images by an external image recording device and is identified with general recording media such as repeatedly rewritable paper or sheets. That is, recording and erasing images on a recording medium is carried out by an external image recording device, which is not present in the recording medium. Accordingly, the recording medium does not necessarily require a drive element or a power source for use in PLD to display an image.

The image recording layer contains cells each of which encapsulates: electrophoretic particles and/or magnetophoretic particles; a dispersion medium; and a thermoreversible gelling agent. The electrophoretic particles and/or magnetophoretic particles migrate (move) in the dispersion medium as an electric field and/or magnetic field is externally applied.

The dispersion medium disperses the electrophoretic particles and/or magnetophoretic particles.

The thermoreversible gelling agent turns the dispersion medium into a sol (liquidizes the dispersion medium) as the temperature thereof surpasses a particular temperature, turns the dispersion medium into a gel (solidifies the dispersion medium) as the temperature thereof becomes a particular temperature or lower, and can reversibly induces sol-gel transition depending on temperatures.

The recording medium of the present disclosure contains a thermoreversible gelling agent in the image recording layer. The thermoreversible gelling agent maintains the dispersion medium in a gel state at display or in storage of an image at room temperature and turns it into liquid form at temperatures higher than room temperature to record (write) an image. That is, since the dispersion medium maintains a gel form at display or in storage of an image, the mobility of the electrophoretic particles and/or magnetophoretic particles is limited, thereby suppressing changes of the quality of an image during storage thereof for a long period of time.

In addition, the image is steadily retained on external impacts such as electrostatics or pressure. Moreover, since the dispersion medium is liquidized by heat applied at the time of recording (writing), the electrophoretic particles and/or magnetophoretic particles freely move in the image recording layer. According to this phenomenon, images can be repeatedly recorded and erased.

Although thermoreversible gelling agent is not suitable for PLD because PLD requires quick image writing, the recording (writing) speed achieved by using a thermoreversible gelling agent is suitably applicable to a rewritable recording medium having a purpose like paper.

In a case where an image recording layer containing a thermoreversible gelling agent is used as an internally driven PLD having a drive element therein and capable of displaying an image by itself like a conventional technique, it is necessary to house, in the display, a heating device or a cooling device as well in addition to a display driving device to apply an electric field to the display. Accordingly, the size and weight of the display increase. Moreover, it is necessary to make the temperature up and down every time images are rewritten, which arises problems such that display speed becomes slow and a sufficient display contrast ratio is not obtained.

However, the recording medium of the present disclosure is not a PLD but to record images by an external image recording device, which obviates the need of providing the recording medium itself with devices to heat and cool. Accordingly, these devices can be provided separately in an image recording device from the recording medium. That is, the problems involved with PLD such as an increase of the size and weight of the recording medium, low display speed, and insufficient display contrast ratio, can be removed. That is, the recording medium can be like paper.

Accordingly, unlike PLD, low display speed ascribable to a thermoreversible gelling agent does not make a problem for the recording medium of the present disclosure and it has a good point of retaining images semi-permanently by using the thermoreversible gelling agent.

The recording medium of the present disclosure contains multiple cells in the image recording layer. Normally, these cells are spaced a constant distance apart. These cells have a configuration encapsulating electrophoretic particles and/or magnetophoretic particles, a dispersion medium, and a thermoreversible gelling agent. Due to this, deviation of the electrophoretic particles and/or magnetophoretic particles are significantly reduced, thereby maintaining the gap in the image recording layer. As a result, image retention (retentiveness) and the stability of writing and erasing images are improved. In addition, if there are no cells, the gel in a recording medium is cracked if the recording medium is bent, which has an adverse impact on the quality of image. This problem is solved by providing such cells in some cases.

The form of the cell has no specific limit. However, if the cell has a wall having a narrow inner angle, electrophoretic particles and/or magnetophoretic particles tend to accumulate at the angle portion. In order to avoid this, the inner angle should be 90 or more. Therefore, it is most preferable for the cell to have a honeycomb having a hexagon form. Also, a honeycomb form is expected to enhance the strength of the recording medium.

The recording medium of the present disclosure using the cell mentioned above can be manufactured easily by, for example, forming the cell on the first substrate and providing the second substrate and/or a protective layer thereon. Since such a simple method is used to manufacture the recording medium, the productivity thereof is improved, which is advantageous in terms of cost.

The form of the cell can be a microcapsule, which is significantly useful.

When using a microcapsule as the cell, the dispersion medium in the microcapsule can be reversibly changed from sol to gel or the other way round depending on temperatures by encapusulating the thermoreversible gelling agent in the microcapsules together with electrophoretic particles and/or magnetophoretic particles and the dispersion medium. As a result, the dispersion medium in the microcapsule is immediately liquidized when heated to temperatures higher than room temperature. Accordingly, electrophoretic particles and/or magnetophoretic particles can migrate by applying an electric field and/or a magnetic field. If the microcapsule is cooled down thereafter, the electrophoretic particles and/or the magnetophoretic particles do not migrate even when an electric field and/or a magnetic field is applied. For this reason, images can be retained semi-permanently.

The dispersion medium in the microcapsule little or never evaporates, which is advantageous to improve the stability of repeating writing images. In addition, since it is possible to form a microcapsule layer on a substrate by coating, a simple method such as a roll to roll can be used, which is advantageous in terms of cost. Therefore, the cell using a microcapsule is preferable among others.

Substrate

There is no specific limit to the material for the substrate. Specific examples thereof include, but are not limited to, plastics such as synthetic resins and natural resins, paper, water-proof paper, thin glass, metal plates, and wood plates. Of these, synthetic resins are preferable in terms of flexibility and transparency.

There is no specific limit to the synthetic resin and suitable dsynthetic resins can be selected to a particular application.

Specific examples thereof include, but are not limited to, polyethylene, chlorinated polyethylene, ethylene-vinyl acetate copolymer, ethylene-ethyl acrylate copolymer, polypropylene, polybutadiene, an AS resin, an ABS resin, a methyl methacrylate resin, a vinyl chloride resin, vinyl chloride-vinyl acetate copolymer, vinyl chloride-vinylidene chloride copolymer, vinyl chloride-acrylic ester copolymer, vinyl chloride-methacrylic acid copolymer, vinyl chloride-acrylonitrile copolymer, ethylene-vinyl alcohol-vinyl chloride copolymer, propylene-vinyl chloride copolymer, a vinylidene chloride resin, a vinyl acetate resin, methacrylic acid-styrene copolymer, a polybutyrene resin, methyl methacrylate-butadiene-styrene copolymer, polyvinyl alcohol, polyvinyl formal, a cellulose-based resin, a polyamide-based resin, a polyimide-based resin, a polyacetal resin, a polycarbonate resin, a urethane-based resin, a polyester resin (e.g., a polyethylene terephthalate resin, and a polybutyrene terephthalate resin), a polyphenylene oxide resin, a polysulfone resin, a polyamideimide resin, a polyamino bismaleimide resin, a polyether sulfone resin, a polyphenylene sulfone resin, a polyacrylate resin, a grafted polyphenylene ether resin, a polyether ether ketone resin, a polyether imide resin, a fluorine-based resin (e.g., a polytetrafluoroethylene resin, a polyfluoroethylene propylene resin, tetrafluoroethylene-perfluoroalkoxy ethylene copolymer, ethylene-tetrafluoroethylene copolymer, polyvinylidene fluoride, polychlorotrifluoroethylene, and fluoro rubber), and a silicone-based resin (e.g., a silicone resin, and silicone rubber).

These may be used alone or in combination of two or more thereof.

The substrate can be formed of a resin curable by light, heat, electron beams, etc. to enhance damage resistance and abrasion resistance of the recording medium of the present disclosure. Examples of such resins include, but are not limited to, photocurable resins and thermocurable resins. In the present disclosure, of these curable resins, acrylic resins, diallyl phthalate resins, epoxy-based resins, urethane resins, melamine resins, and alkyd resins are preferably used.

As the substrate for use in the present disclosure, it is possible and suitable to use a film molded from the synthesized resins mentioned above. Specific examples of such resin films include, but are not limited to, polyolefin-based resin film such as polyethylene film, polypropylene film, and ethylene copolymer film, polyester-based film such as polyethylene naphthalate and aromatic polyesters, polyamide-based film such as Nylon 6, MXD6, and aramid, polyimide film, polyether imide film, polyetherether ketone film, polyether sulfone film, polypheneylene sulfide film, triacetyl cellulose film, polycarbonate film, polystyrene film, polyacrylonitril film, polyvinylchloride film, polyvinilydene chloride film, polyvinyl alcohol film, polyvinylbutyral film, film of copolymer of ethylene and vinyl acetate, film of copolymer of ethylene and vinylalcohol, film of copolymer of ethylene and methacylic acid, ionomer resin film, acrylic film, polyurethane film, and fluorine-containing resin film.

In addition, since these resin films have characteristics that the strength thereof can be enhanced by extending them in a fixed direction while being heated because the molecules thereof are aligned in the deformation direction, films extended along one or two axis direction can be suitably used. In addition, one or both sides of these resin films can be subject to surface treatment such as corona treatment, plasma treatment, frame treatment, or acid alkali treatment. Furthermore, it is possible and suitable to for example, apply, deposit, or ion-plate a coating agent to one or both sides of these resin films. Using these methods, it is possible to impart reflection protection functionality or finger print attachment prevention features, improve abrasion resistance and damage resistance, or impart anti-stat properties.

In the present disclosure, polyethylene terephthalate film, polyethylene naphthalate film, polyimide film, nylon(polyamide)film, and triacetyl cellulose film are preferable resin films

Also, it is possible and suitable to impart electroconductivity to a substrate. Voltage drop by a substrate is suppressed and the intensity of the electric field of an image recording layer can be boosted by using an electroconductive substrate. For this reason, images having a high contrast can be obtained by a lower drive voltage. “Electroconductivity” means nature of conducting electricity and is indicated by electroconductivity or resistivity (inverse of electroconductivity). If measured by using a resistivity meter, surface resistivity or volume resistivity can be obtained. A specific example of such a resistivity meter available on market is Hiresta or Loresta, manufactured by Mitsubishi Chemical Analytech Co., Ltd.

The electroconductive substrate is classified into a substrate having an electroconductive surface layer and a substrate having electroconductivity. The substrate having an electroconductively-treated surface can be obtained by providing an electroconductive film to the surface of a substrate formed of plastic film, glass, etc., which has insulation property. Such electroconductive film is formed on the surface of a substrate and specific examples of the electroconductive film include, but are not limited to, metal, metal leaf, plated metal, or deposited metal of ITO (indium tin oxide), zinc oxide, gold, silver, copper, aluminum, chromium, tin, nickel, etcl, silver nanowire, graphene, carbon nanotube, electroconductive polymer, or mixtures thereof. The surface resistivity of these electrconductive film layer is preferably from 10⁷ Ω·cm or less, more preferably from 10³ Ω·cm or less, and furthermore preferably from 10¹ Ω·cm or less. The substrate on the side from which a recording medium is viewed is preferably transparent. It is preferable to use a transparent substrate having a surface to which a transparent film is provided.

Also, a substrate having electroconductivity is preferable. A substrate having electroconductivity obviates the need of providing an electrode separately, which is convenient in some cases. However, since a substrate having electroconductivity used is not transparent in many cases, it is preferable to use such a substrate on the reverse side of a recording medium to the side to be viewed. The electroconductive substrate can be any electroconductive substrate and specific examples thereof include, but are not limited to, metal plates, metal sheets, and metal leafs of gold, silver, copper, aluminum, chrome, tin, nickel, and iron, carbon sheets or carbon paper formed of carbon or graphite, electromagnetic shield film or sheet, electroconductive paper, electroconductive cloth, electroconductive glass, and electroconductive plate. An elecroconductive substrate obviates the need of a separate electrode but has to have a low volume resistivity in addition to a low surface resistivity. The volume resistivity of these electrconductive substrate is preferably from 10⁷ Ω·cm or less, more preferably from 10³ Ω·cm or less, and furthermore preferably from 10¹ Ω·cm or less.

Moreover, it is possible and suitable to add an electroconductive filler to at least one of the first substrate and the second substrate to serve as the electroconductive substrate. This filler means bulking agents or filing. Anything solid contained in a substrate is regarded as a filler. Specific examples of such fillers include, but are not limited to, metal particulates, metal flakes, metal fiber, metal fiber resins, metal coating fiber, metal coating particles of copper, silver, gold, aluminum, nickel, iron, steel, platinum, zinc, etc.; electroconductive metal oxides such as silica, titanium oxide, alumina, magnesium oxide, berylium oxide, tin oxide, and indium oxide with which antimony, tin, aluminum, etc., are doped; and carbon powder, carbon fiber, or carbon flake of carbon compounds such as black lead, carbon black, carbon nanotube, fullerene, and graphite.

Whether a substrate having an electroconductive surface layer or a substrate having electroconductivity is used, it is preferable that the substrate is formed to be electrically connected with both an image recording layer and the exterior of the recording medium. As a result, an electric field is directly applied to the image recording layer from an image recording device. In a case of the substrate having an electroconductive surface, an electrode is provided to the exterior of a recording medium for electric connection with the electroconductive surface layer.

An electroconductive substrate for use in a recording medium can be formed at least one of the first substrate and the second substrate. By this formation, a high contrast image can be obtained by a lower drive voltage. In a system in which the entire of the recording medium is heated to liquidize the dispersion medium in all the cells or microcapsules followed by application of an electric field to a recording area to migrate particles therein to record an image, if an electroconductive substrate is used on the side to which the electric field is applied to record the image, image flow tends to occur or no image is easily recorded. For this reason, it is preferable to use an electroconductive substrate only on the side opposite to the side to which an electric field is applied. On the other hand, in a case in which a recording area is heated to migrate particles therein to record an image while an electric field is applied to the entire of the recording medium, there is no restriction as described above. Accordingly, it is preferable to form an electroconductive substrate both on the first substrate and the second substrate.

Since providing an electroconductive substrate both on the first substrate and the second substrate is more advantageous to only one of them in terms of high contrast, reduction of drive voltage, and durability of a recording medium, the latter structure is preferable in the present disclosure.

The recording medium of the present disclosure has an image recording layer between a first substrate and a second substrate, but materials of the first substrate can be the same as or different from those of the second substrate.

Forms of the first substrate and the second substrate can be any form and are appropriately selected depending on a particular purpose, and an example thereof is a sheet-like form.

The first substrate and the second substrate are preferably transparent at least on the side from which the recording medium is viewed. The substrate provided on the opposite side to the side from which the recording medium is viewed may be transparent, translucent, or opaque. In some cases, a high contrast ratio can be attained and visibility can be enhanced by providing an opaque (e.g., white, black, and mono-color) substrate at the opposite side to the side from which the recording medium is viewed. For example, the recording medium can be produced by using a transparent substrate for the first substrate, which is provided at the side from which the recording medium is viewed and a translucent or opaque substrate for the second substrate, which is provided at the opposite side to the side from which the recording medium is viewed. Moreover, it is possible and suitable to use paper as opaque substrate.

To prepare an opaque substrate, it is suitable to add fillers such as titanium oxide and carbon black to a substrate. For example, a white substrate is obtained by adding titanium oxide and a black substrate is obtained by adding carbon black. In addition, known pigments and particulates can be added to a substrate to obtain a colored substrate.

Moreover, to obtain a white substrate, it is suitable to form many flat voids in a substrate to make the substrate look white by multipath reflection occurring at the interface of the flat voids.

The average thickness of the substrate has no specific limit and is appropriately selected depending on the intended purpose, but it preferably ranges from 10 m to 1,000 m, more preferably from 20 m to 500 m, and particularly preferably from 30 m to 200 m.

The average thickness of each of the first substrate and the second substrate is preferably from 5 m to 500 m, more preferably from 10 m to 250 m, and even particularly preferably from 15 m to 100 m. In this case, the average thicknesses of the first substrate and the average thickness of the second substrate may be the same or different.

When the average thickness of the substrate is less than 10 m, wrinkles and bends may occur, which leads to formation of defective images at the portion where the wrinkles and bends are formed. In addition, when the average thickness of the substrate is greater than 1,000 m, flexibility and portability (thin film, light weight) tend to be insufficient or a high voltage or magnetic field has to be applied at the time of recording (writing).

Image Recording Layer

The image recording layer has multiple cells encapsulating a liquid dispersion containing at least electrophoretic particles and/or magnetophoretic particles, a dispersion medium, and a thermoreversible gelling agent. The cells optionally encapsulates other components.

A method of producing multiple cells each encapsulating a liquid dispersion containing at least electrophoretic particles and/or magnetophoretic particles, a dispersion medium, and a thermoreversible gelling agent is appropriately selected depending on a particular purpose without any limit, provided that the method uses a structure where the liquid dispersion is encapsulated in multiple cells spaced a particular gap.

For example, cells can be formed by using a method including steps of applying a thermoplastic resin or a curable resin onto a substrate and pressing a mold against the applied resin to provide cells followed by microembossing process, thereby forming multiple cells spaced a particular gap. Also, a method is suitable which includes steps of applying a material for forming cells onto a template in which recesses are regularly formed, so as to cover the recesses with the material, and thereafter reducing the pressure of the surrounding air to relatively expand air bubbles present in the recesses at the same time, thereby forming cells.

The recording medium of the present disclosure can be produced by providing, on a substrate, the multiple cells spaced a particular gap in the aforementioned manner, placing, in the cells, a liquid dispersion containing at least electrophoretic particles and/or magnetophoretic particles, a dispersion medium, and a thermoreversible gelling agent, and bonding a substrate thereon so as not let in any air bubbles.

The aforementioned method includes a coating process and enables continuous production, which is very advantageous for low cost production. Moreover, as the cells have wide openings, the recording medium produced by such a method easily achieves high contrast.

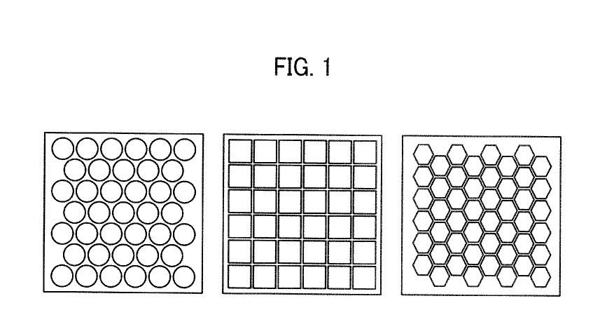

The form of each cell can be any form in which the liquid dispersion is separated by multiple cells. For example, as illustrated in FIG. 1, cells of various shapes, such as polygons, circles, and ovals can be provided.

Incidentally, preferred as shapes of the cells are those each having a cell area as least as possible and those each having a large angle so as to prevent the particles from accumulating at corners of the cell. The former is preferably a rectangular and the latter is preferably a circle.

In order to strike a balance therebetween, the forms of the cells are particularly preferably a hexagonal honeycomb shape. In addition, the honeycomb shape is also particularly preferable in terms that it enhances the strength of the image recording layer.

In a case in which microcapsules are used, a production method of the microcapsules is appropriately selected depending on the intended purpose without any limitation, and specific examples thereof include, but are not limited to, conventional methods known in the art, such as a complex coacervation method, an interfacial polymerization method, and an in situ polymerization method. By the coacervation method, microcapsules are formed by separating a uniform phase into a polymer-rich phase and a polymer-poor phase by lowering the temperature of a polymer solution, so that coacervated small droplets of the polymer-rich phase dispersed in the polymer-poor phase adhere to the surfaces of dispersed particles, the state of which is fixed.

A specific example of materials used in the coacervation is gelatine-Arabian gum. In the microcapsulation by the interfacial polymerization method, a hydrophobic monomer and a hydrophilic monomer are combined to form layers in reaction at the interface of emulsion droplets. In the microcapsulation by the in situ polymerization method, which is also referred to as an interface reaction method, wall layer materials of monomers, prepolymers, etc. and polymerization catalysts are provided around core materials to conduct polymerization reaction at the surface (interface) of the core materials, thereby forming a layer. Specific example of the materials include, but are not limited to, urea-formaldehyde and melamine-formaldehyde. Also, a phase separation method, a liquid drying method, and a liquid curing layer forming method are also suitable.

Taking into account of migration of the particles in each microcapsule, the form of each microcapsule is preferably spherical, i.e., a cross-section of each microcapsule is preferably a circle. In reality, however, it is more preferable in view of the image quality that microcapsules are closely packed without a space between the microcapsules. Therefore, the cross-section of each microcapsule is also preferably oval or polygon to improve the contrast of images. Furthermore, the form thereof has not specific limit and can be a mixture of those.

The size of the microcapsule is preferably from 1 m to 500 m, more preferably from 10 m to 100 m, and furthermore preferably from 20 m to 80 m. Although large microcapsules are suitable to improve contrast, the drive voltage is increased or images exude in some cases. In contrast, small microcapsules are advantageous about image exuding and drive voltage but have a negative impact on contrast in some cases. When the size is excessively small, the concentration is low even in image reverse, the contrast of an image excessively become low in some cases. The size of the microcapsules in the present disclosure is defined as the diameter for a circle form, the major diameter for an ellipse form, and the longest diagonal for a polygon form.

The size of microcapsules is determined by observing a microcapsule layer formed on a substrate by an optical microscope or the like. For example, the size is determined by calculating the average of the measuring values of, for example, 50 microcapsules to 100 microcapsules arbitrarily selected from the microcapsules observed by an optical microscope.

The size of microcapsules can be controlled by, for example, a sieve. For example, microcapsule slurry is screened by multiple sieves having different meshes to obtain microcapsules having a desired size range. In addition, wet classifiers or centrifugals can be used.

The microcapsule layer formed between substrates is preferably a single layer in terms of improvement of the quality of image. If a microcapsule layer is formed by a single layer without being overlapped, a drive voltage is decreased, contrast is improved, and non-uniform density is reduced in some cases. In addition, the size of the microcapsule is preferably the same. Microcapsules having the same size has a positive impact on the decrease of non-uniform density.

By using microcapsules, it is possible to prevent evaporation of a dispersion medium, which leads to a stable long working life of a recording medium. Since the recording medium of the present disclosure is heated at every recording or erasure of images, prevention of vaporization of the dispersion medium is particularly preferable to achieve high level image quality, high stability, and long service life of the recording medium. To this end, use of the microcapsules is more preferable. In addition, a recording medium using a microcapsule as cell is advantageous in that it can be rolled up or bent without leaking the liquid solvent.

Moreover, slurry of the microcapsules makes it possible to manufacture recording media by a coating process, which is advantageous for low cost production.

The microcapsules formed on the substrate has to be fixed thereon and a binder resin is preferably used for fixing. The binder resin also serves to secure insulating properties of the image recording layer in addition to fixing of microcapsules. In particular, in a case where electric conductive layers or electric conductive substrates are provided above and below the microcapsules, it is not possible to apply an electric field to the image recording layer of an image recording medium unless the image recording layer has insulating properties. If an electric field is not applied, the particles in the image recording layer do not migrate, thereby failing to record images.

As for the binder resin, suitably used is a resin having excellent insulating properties and high affinity or adhesion to a substrate, electronic conductive layer, or microcapsules. The kind of the resin for use is not particularly limited. Specific examples thereof include, but are not limited to, a thermoplastic resin and a curable resin known in the art. Thermo- or photo-curable resins are more preferable. A microcapsule layer having insulation properties is easily formed on a substrate by mixing any of these binder resins with the microcapsules and applying the mixture onto the substrate followed by drying. Accordingly, art image recording layer having insulating properties can be formed.

In a case where the microcapsules are not mixed with water, various resin materials can be used. In a case of slurry in which the microcapsules are mixed with water, an aqueous resin is preferably used. Of such aqueous resins, a resin to which a hydrophilic group or hydrophilic segment is provided, an emulsion in which a hydrophilic resin is forcibly emulsified using a surfactant, a prepolymer which is blocked with a blocking agent having an hydrophilic group, or a blocked prepolymer to which a hydrophilic segment has been provided are preferable, and an aqueous urethane resin having such functionality is particularly preferable.

It is preferable to make the image recording layer be insulated by using only a binder resin mixed with the microcapsules. In a case where insulating properties are not sufficient, it is possible to further apply an insulating resin onto the microcapsule layer to form an image recording layer, and this method is suitable to maintain insulating properties of the image recording layer. If a microcapsule is a slurry mixed with water but once can be applied to a substrate to form a layer together with an aqueous resin, even a mixture of a resin and an organic solvent can be applied to the layer. Therefore, the insulating resin can be selected from a wide range of resins. However, if the insulating resin layer is significantly thicker than the microcapsule layer, the image recording layer becomes thick, thereby weakening the electric field, so that images having low contrast may be produced. Accordingly, it is desirable that the insulating resin layer is not significantly thicker than the microcapsule layer.

In the present disclosure, the binder resin for use in the image recording layer or the layer formed to maintain the insulating properties of the image cording layer or protect microcapsules can be formed of the same material as that of the substrate. That is, the image recording layer and the substrate for use in the present disclosure do not necessarily have an interface. If a resin, how slight the amount thereof may be, is attached to the microcapsule, it can be regarded as a substrate. For example, in an image recording layer formed by applying a liquid dispersion in which microcapsules are mixed with a binder resin to a first substrate, if the reverse side of the microcapsule on the first substrate is covered with a binder resin, the binder resin is regarded as the second substrate.

Electrophoretic Particles and Magnetophoretic Particles

The image recording layer provided to the recording medium of the present disclosure optionally contain colored electrophoretic particles and magnetophoretic particles. In such a case, the multiple cells to form an image recording layer are grouped by the color or the combination of the colors of the electrophoretic particles and/or the magnetophoretic particles.

The sol transition temperatures and/or gel transition temperatures of the dispersion media contained in the cells are set to be different from each other depending on the color of the electrophoretic particles and/or the magnetophoretic particles or combination colors thereof.

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

To be more specific, each cell contains electrophoretic particles and/or magnetophoretic particles having two or more colors and the sol transition temperature and/or the gel transition temperature of a dispersion medium contained in each cell is different depending on the combination of the colors of the electrophoretic particles and/or the magnetophoretic particles. Also, another specific example is that each cell contains electrophoretic particles and/or magnetophoretic particles and a dispersion medium having a color by a colorant which is different from that of the electrophoretic particles and/or the magnetophoretic particles and the sol transition temperature and/or the gel transition temperature of the dispersion medium is different depending on the color of the dispersion medium. Incidentally, each of the cells having different sol transition temperatures and/or gel transition temperatures can be arranged at random or regularly.

An example of the image recording method in the configuration described above is described below.

For example, cells containing white particles are defined as cells A and cells containing red particles are defined as cells B. The dispersion media are colored black for both cells A and cells B. Also, the following relations are satisfied: Sa>Ga>Sb>Gb, where Sa represents the sol transition temperatures of the dispersion media contained in the cells A, Ga represents the gel transition temperatures of the dispersion media contained in the cells A, Sb represents the sol transition temperatures of the dispersion media contained in the cells B, and Gb represents the gel transition temperatures of the dispersion media contained in the cells B. In this case, initially, black and white images are recorded in the cells A by heating the recording media therein to temperatures higher than Sa. Thereafter, red and black images are recorded in the cells B by heating the recording media therein to temperatures lower than Ga but higher than Sb (the cells A are gelated and the cells B are solated). Accordingly, without affecting the images in the cells A, the red and black image have been recorded in the cells B, so that the white, red, and black images have been recorded.

As another example, if the following relation is satisfied: Sa>Sb>Ga≈Gb, initially, black and white images are recorded in the cells A by heating the recording media therein to temperatures higher than Sa. Thereafter, the recording media are cooled down to temperatures to Ga (nearly equal to Gb) or lower (both the cells A and the cells B are gelated) and then heated to temperatures lower than Sa but higher than Sb to record red and black images in the cells B.

Accordingly, without affecting the images in the cells A, the red and black image have been recorded in the cells B, so that the white, red, and black images have been recorded.

As yet another example, if the following relation is satisfied: Sa nearly equal to Sb>Ga>Gb, initially, black and white images are recorded in the cells A by heating the recording media therein to temperatures higher than Sa. Thereafter, red and black images are recorded in the cells B by heating the recording media therein to temperatures lower than Ga but higher than Gb (the cells A are gelated and the cells B are solated). Accordingly, without affecting the images in the cells A, the red and black image have been recorded in the cells B, so that the white, red, and black images have been recorded.

In addition, if the combination of the colors of the particles is different, for example, cells containing white particles and black particles are defined as cells C and cells containing white particles and red particles are defined as cells D. When the dispersion media are transparent for both cells C and cells D. Also, the following relations are satisfied: Sc>Gc>Sd>Gd, where Sc represents the sol transition temperatures of the dispersion media contained in the cells C, Ge represents the gel transition temperatures of the dispersion media contained in the cells C, Sd represents the sol transition temperatures of the dispersion media contained in the cells D, and Gd represents the gel transition temperatures of the dispersion media contained in the cells D. In this case, initially, black and white images are recorded in the cells C by heating the recording media therein to temperatures higher than Sc. Thereafter, red and white images are recorded in the cells d by heating the recording media therein to temperatures lower than Gc but higher than Sd (the cells C are gelated and the cells D are solated).

Accordingly, without affecting the images in the cells C, the red and black image have been recorded in the cells D, so that the white, red, and black images have been recorded.

As another example, if the following relation is satisfied: Sc>Sd>Gc nearly equal to Gd, initially, black and white images are recorded in the cells C by heating the recording media therein to temperatures higher than Sc. Thereafter, the recording media are cooled down to temperatures to Gc (nearly equal to Gd) or lower (both the cells C and the cells D are gelated) and then heated to temperatures lower than Sc but higher than Sd to record red and black images in the cells D. Accordingly, without affecting the images in the cells C, the red and black image have been recorded in the cells D, so that the white, red, and black images have been recorded.

As yet another example, if the following relation is satisfied: Sc nearly equal to Sd>Gc>Gd, initially, black and white images are recorded in the cells C by heating the recording media therein to temperatures higher than Sc. Thereafter, red and black images are recorded in the cells D by heating the recording media therein to temperatures lower than Gc but higher than Gd (the cells C are gelated and the cells D are solated). Accordingly, without affecting the images in the cells C, the red and black image have been recorded in the cells D, so that the white, red, and black images have been recorded.

Similarly, it is possible to provide three or more kinds of cells containing dispersion media having different sol transition temperatures and/or gel transition temperatures per the color or the combination of the colors of dyes or particles contained in the dispersion media, which makes it possible to provide more display colors.

The method of making the sol transition temperature and/or the gel transition temperature of dispersion media contained in cells different depending on the color of electrophoretic particles and/or magnetophoretic particles or the combination of the colors has no specific limit but preferably a method of changing the kind of thermoreversible gelling agents contained, a method of changing the addition amount of thermoreversible gelling agents, and a method of changing dispersion media. These are described later.

The electrophoretic particles are appropriately selected depending on the intended purpose without any limitation, provided that they are particles that can exhibit electrophoresis in a fluid dispersion medium upon application of electric field. Specific examples thereof include, but are not limited to, an organic pigment and an inorganic pigment. A type of the pigment may be selected depending on the color of an image to be recorded in the recording medium of the present disclosure.

An example of the electrophoretic particles is described below.

Specific examples of black electrophoretic particles include, but are not limited to, carbon black, aniline black, titanium black, furnace black, lamp black and black iron oxide.

Specific examples of red electrophoretic particles include, but are not limited to, rhodamine 6G lake, dimethylquinacridone, watching red, lake red C, brilliant carmine 6B, rose Bengal, rhodamine B, alizarin lake, lithol red, permanent red 4R, and benzidine red.

Specific examples of yellow electrophoretic particles include, but are not limited to, chrome yellow, benzidine yellow, hansa yellow, naphthol yellow, molybdenum yellow, quinoline yellow and tartrazine.

Specific examples of blue electrophoretic particles include, but are not limited to, phthalocyanine blue, methylene blue, cobalt blue, victoria blue, methyl violet, aniline blue, ultramarine blue, sky blue, indanthrene blue and cerulean blue.

Specific examples of green electrophoretic particles include, but are not limited to, phthalocyanine green, malachite green lake, naphthol green, emerald green, viridian, cobalt green and chrome oxide.

Specific examples of purple electrophoretic particles include, but are not limited to, fast violet, methyl violet lake, indigo, mineral violet and cobalt violet.

Specific examples of brown electrophoretic particles include, but are not limited to, toluidine maroon, indanthrene red violet RH, burnt umber and iron oxide.

Specific examples of white electrophoretic particles include, but are not limited to: metal oxide, such as titanium oxide, zinc oxide, antimony oxide, aluminum oxide, and silicon dioxide; barium titanate; and barium sulfate.

These may be used alone or in combination of two or more thereof.

It is also possible to use white electrophoretic particles, which have been colored with various colorants, such as the aforementioned pigments or dyes.

In addition, in the present disclosure, electrophoretic particles can be suitably used as the electrophoretic particles. Electret particles have semi-permanently charges by, for example, methods using electron beams, radiation ray, corona discharging, etc. By using electret particles, the charging size of particles can be uniformed, which is advantageous to the quality of images in some cases.

In order to enhance the dispersibility of the electrophoretic particles in the dispersion medium, prevent aggregations thereof, and stably migrate electrophoretic particles, it is preferable that the electrophoretic particles are subject to surface treatment.

A coupling agent is mainly used for the surface treatment. Specific examples of the coupling agent include a chromium-based coupling agent, a silane-based coupling agent, a titanate-based coupling agent, an aluminum-based coupling agent, a zirconium-based coupling agent, a zircon-alumminate coupling agent and a fluorine-based coupling agent.

As for the surface treatment, also suitable are a method for forming graft chains on the surfaces of electrophoretic particles and a method for coating the surfaces of electrophoretic particle with a polymer.

The magnetophoretic particles are appropriately selected depending on the intended purpose without any limitation, provided that they are particles that can exhibit magnetophoresis in a fluid dispersion medium upon application of magnetic field. Specific examples thereof include, but are not limited to, a ferromagnetic material, such as ferromagnetic metal (e.g., iron, nickel, and cobalt) and an alloy containing the ferromagnetic metal; and permanent magnet, such as ferrite magnet, and alloy magnet.

Specific examples thereof include, but are not limited to, black iron oxide, porous iron oxide, black magnetite, γ-hematite, manganese dioxide-containing iron oxide, chromium dioxide, ferrite, iron, nickel, cobalt, gadolinium and alloys thereof.

It is also possible to use magnetophoretic particles having surfaces colored by various colorants.

For the purpose of enhancing the dispersibility of the electrophoretic particles and/or magnetophoretic particles in the dispersion medium, preventing aggregations thereof, and achieving stable electrophoresis, it is preferred that the electrophoretic particles and/or magnetophoretic particles are subject to a surface treatment.

A coupling agent is mainly used for the surface treatment. Specific examples of the coupling agent include, but are not limited to, a chromium-based coupling agent, a silane-based coupling agent, a titanate-based coupling agent, an aluminum-based coupling agent, a zirconium-based coupling agent, a zircon-alumminate coupling agent and a fluorine-based coupling agent.

As for the surface treatment, also suitable are a method for forming graft chains on surfaces of the electrophoretic particles and/or magnetophoretic particles and a method for coating surfaces of the electrophoretic particles and/or magnetophoretic particles with polymer.

The average particle diameter of the electrophoretic particles and/or the magnetophoretic particles is appropriately selected depending on the intended purpose without any limitation. It is preferably from 0.01 m to 20 m, more preferably from 0.03 m to 5 m, and particularly preferably from 0.1 m to 1 m. When the average particle diameter thereof is too large, the responsiveness of particles tends to be low, or the dissolution of an image tends to be low. When the average particle diameter thereof is too small, particles are easily aggregated to each other, or the image density of a resulting image tends to be low.

The average particle diameter means the particle diameter of the average primary particle diameter representing a particle group and is represented by the number average particle diameter. Specifically, particles are directly taken out, or the recording medium of the present disclosure is cut and the section thereof is directly observed under an electron microscope.

Thereafter, the primary particle diameters of the particles are determined and the average value of these primary particle diameters (for example, the average value of 100 particles) is calculated and determined as the average particle diameter.

Electrophoretic particles and/or magnetophoretic particles can be used alone or in combination. In a case where one kind of particles is used, an image can be formed by coloring the dispersion medium and coloring the particles with a color distinctive from that of the dispersion medium. In a case where two kinds of particles are used, images can be formed by using two groups of particles having different colors and charge polarities. Alternatively, if three or more kinds of particles are used, images can be formed by a combination of two or more kinds of the electrophoretic particles and/or magnetophoretic particles and one kind of non-electrophoretic particles and/or non-magnetophoretic particles.

The particles to record images in the recording medium of the present disclosure can be either of the electrophoretic particles or magnetophoretic particles, which form images upon application of electric field or magnetic field, respectively. In view of the image quality and recording speed, the electrophoretic particles are preferably used.

However, it is to be noted that it is possible to use the electrophoretic particles and the magnetophoretic particles in combination. By providing an image recording device with a device to apply an electric field and magnetic field, the electrophoretic particles and the magnetophoretic particles having distinctive colors from each other are individually controlled. As a result, the number of display colors be increased.

There is no specific limit to the amount of the electrophoretic particles and/or magnetophoretic particles in the image recording layer. It is appropriately determined to a particular application.

Dispersion Medium

The image recording layer provided to the recording medium of the present disclosure optionally contain a colorant and a dispersion medium. In such a case, multiple cells to form an image recording layer are grouped by the color of the dispersion medium by the colorant. The sol transition temperatures and/or gel transition temperatures of the dispersion media contained in the cells are set to be different from each other depending on the color of the dispersion medium. Incidentally, each of the cells having different sol transition temperatures and/or gel transition temperatures can be arranged at random or regularly.

An example of the image recording method in the configuration described above is described below.

For example, cells containing white particles, a black colorant, and a dispersion medium are defined as cells E and cells containing white particles, a red colorant, and a dispersion medium are defined as cells F. The following relations are satisfied: Se>Ge>Sf>Gf, where Se represents the sol transition temperatures of the dispersion media contained in the cells E, Ge represents the gel transition temperatures of the dispersion media contained in the cells E, Sf represents the sol transition temperatures of the dispersion media contained in the cells F, and Gf represents the gel transition temperatures of the dispersion media contained in the cells F. In this case, initially, black and white images are recorded in the cells E by heating the recording media therein to temperatures higher than Se. Thereafter, red and white images are recorded in the cells d by heating the recording media therein to temperatures lower than Ge but higher than Sf (the cells E are gelated and the cells F are solated). Accordingly, without affecting the images in the cells E, the red and white image have been recorded in the cells F, so that the red, white, and black images have been recorded.

As another example, if the following relation is satisfied: Se>Sf>Ge nearly equal to Gf, initially, black and white images are recorded in the cells E by heating the recording media therein to temperatures higher than Se. Thereafter, the recording media are cooled down to temperatures to Ge (nearly equal to Gf) or lower (both the cells E and the cells E are gelated) and then heated to temperatures lower than Se but higher than Sf to record red and white images in the cells F. Accordingly, without affecting the images in the cells E, the red and white image have been recorded in the cells F, so that the white, red, and black images have been recorded.

As yet another example, if the following relation satisfied: Se nearly equal to Sf>Ge>Gf, initially, black and white images are recorded in the cells E by heating the recording media therein to temperatures higher than Se. Thereafter, red and black images are recorded in the cells F by heating the recording media therein to temperatures lower than Ge but higher than Gf (the cells E are gelated and the cells F are solated). Accordingly, without affecting the images in the cells E, the red and black image have been recorded in the cells F, so that the white, red, and black images have been recorded.

Similarly, it is possible to provide three or more kinds (groups) of cells containing dispersion media having different sol transition temperatures and/or gel transition temperatures depending on the color of the dispersion medium by the colorant, which makes it possible to increase the number of display colors.

The dispersion medium can be any dispersion medium that can disperse electrophoretic particles and/or magnetophoretic particles and selected to a particular application. Specific examples of the dispersion medium include, but are not limited to, an organic solvent, silicone oil, and water. Of these, an organic solvent and silicone oil are preferable in view of migraion, responsiveness, and image retentiveness of the electrophoretic particles and/or magnetophoretic particles.

Specific examples of the organic solvent include, but are not limited to, an alcohol-based solvent, such as methanol, ethanol, and isopropanol; chain or cyclic aliphatic hydrocarbons, such as pentane, hexane, heptane, octane, nonane, decane, dodecane, isohexene, isodoctane, isododecane, tetradecane, dodecylbenzene, cyclohexane, kerosene, ISOPAR™, naphthene, liquid paraffin, and petroleum; aromatic hydrocarbons, such as benzene, toluene, xylene, alkyl benzene, solvent naphtha, phenylxyl ethane, diisopropyl naphthalene; and halogenated hydrocarbon, such as carbon tetrachloride, chloroform, dichloromethane, ethyl bromide, trichloroethylene, tetra chloroethylene, trifluoroethylene, tetrafluoroethylene, trichlorotrifluoroethylene, and tetrachlorofluoroethylene.

Of these, a non-polar solvent is preferable and an aliphatic hydrocarbon preferable.

Specific examples of the silicone oil include, but are not limited to: various modified silicone oils, such as dialkyl silicone oil (e.g., dimethyl silicone oil), cyclic dialkyl silicone oil, alkylphenyl silicone oil, cyclic alkylphenyl silicone oil, and polyalkylaralkyl siloxane.

Specific examples of the alkylphenyl silicone oil include, but are not limited to, methyl phenyl silicone oil, ethyl phenyl silicone oil, propyl phenyl silicone oil, butyl phenyl silicone oil, hexyl phenyl silicone oil, octyl phenyl silicone oil, lauryl phenyl silicone oil, and stearyl phenyl silicone oil.

Specific examples of the cyclic alkylphenyl silicone oil include, but are not limited to, cyclic polymethylphenyl siloxane, cyclic polyethylphenyl siloxane, cyclic polybutylphenyl siloxane, cyclic polyhexylphenyl siloxane, cyclic polymethylchlorophenyl siloxane, and cyclic polymethylbromophenyl siloxane.

Specific examples of the polyalkylaralkyl siloxane include, but are not limited to, benzyl-modified silicone nil and methylstyryl-modified silicone oil.

Specific examples of commercial products of the silicone oil include, but are not limited to: KF96 series, KF50 series, KF54, KF56, all manufactured by Shin-Etsu Chemical Co., Ltd.; AK series, AS series, AR series, AP series, and PDM series, all manufactured by Wacker Asahikasei Silicone Co., Ltd.; TSF451 series, TSF456 series, TSF405, TSF4427, TSF431, TSF433, TSF437, and TSF456 series, all manufactured by GE Toshiba Silicone Co., Ltd.; and SH200 series, SH510, SH550, SH556, SH702, SH704, and SH705, all manufactured by Dow Corning Toray Co., Ltd.

These can be used alone or in combination. These may be used alone or combination of two or more thereof.

There is no specific limit to the amount of the dispersion medium in the image recording layer. It can be selected to a particular application.

It is possible to tint the dispersion medium by dissolving, in the dispersion medium, a colorant having the same or different color to that of the electrophoretic particles and magnetophoretic particles. The colorant of the present disclosure can be any colorant that can turn a dispersion medium into white or another various color and can be selected to a particular application.

For example, dyes, non-electrophoretic colored particles, or non-magnetophoretic particles are suitably used.

Specific examples of the oil-soluble dye include, but are not limited to, spirit black (SB, SSBB, AB), nigrosine substrate (SA, SAP, SAPL, EE, EEL, EX, EXBP, EB), oil yellow (105, 107, 129, 3G, GGS), oil orange (201, PS, PR), fast orange, oil red (5B, RR, OG), oil scarlet, oil pink 312, oil violet #730, Macrolex blue RR, Sumiplast green G, oil brown (GR, 416), Sudan black X60, oil green (502, BG), oil blue (613, 2N, BOS), oil black (HBB, 860, BS), Valifast yellow (1101, 1105, 3108, 4120), Valifast orange (3209, 3210), Valifast red (1306, 1355, 2303, 3304, 3306, 3320), Valifast pink 2310N, Valifast brown (2402, 3405), Valifast blue (3405, 1501, 1603, 1605, 1607, 2606, 2610), Valifast violet (1701, 1702), and Valifast black (1802, 1807, 3804, 3810, 3820, 3830).

Non-electrophoretic particles demonstrate no or extremely low electrophoretic properties in an electric field. Any of inorganic or non-organic particles is suitable. Since these non-electrophoretic particles do not migrate in an electric field, a dispersion medium can form a white or colored state. Images are recorded by the electrophoretic particles contained together migrating closer to the imaging side or the rear side, than the non-electrophoretic particles.

Unlike dyes, the non-electrophoretic particles are not transparent, thereby hiding the elctrophoretic particles. As a result, the non-electrophoretic particles are advantageous in some cases to improve the contrast or color representation as a recording medium. A specific preferable example of the organic non-electrophoretic particles is polyvinylnephthalene particles.

In addition, a specific example of the inorganic particles is metal oxide, which can be surface-treated to control chargeability in some cases.

In addition, it is possible to contain the magnetophoretic particles as the non-electrophoretic particles or the electrophoretic particles as the non-magnetophoretic particles. These colorants can be added alone or in combination to the recording medium of the present disclosure.

There is no specific limit to the method of making the sol transition temperature of a dispersion medium contained in cells different by the color of the dispersion medium of the colorant described above. It is preferable to select a method of changing the kind of thermoreversible gelling agents contained, a method of changing the addition amount of thermoreversible gelling agents, and a method of changing dispersion media. Of these, the method of changing dispersion media is described below.

As described above, the dispersion medium can be selected from many kinds. If the kind of the thermoreversible gelling agent contained in the dispersion medium is the same, it is possible to change the sol transition temperature and the gel transition temperature of the recording medium by using different kinds of recording media. For example, if cells containing white particles, a black colorant, and a dispersion medium are defined as cell G and cells containing white particles and a red colorant are defined as cell H, the sol transition temperatures and the gel transition temperatures can be made different by using a dispersion medium Vg as the dispersion medium contained in the cell G and the dispersion medium Vh as the dispersion medium contained in the cell H. For example, when an aliphatic carbon hydrogen-based solvent and silicone oil are compared as the dispersion medium, the latter tends to have a higher sol transition temperature and gel transition temperature. The recording medium of the present disclosure can be easily made by adding the same kind of electrophoretic particles and/or magnetophoretic particles, thermoreversible gelling agent, and colorants having different colors to these.

In addition, to adjust the sol transition temperature or gel transition temperature of a dispersion medium, it is possible to mix different kinds of dispersion media for use, which is preferable to have a desired sol transition temperature and gel transition temperature in some cases. For example, if the kind of the dispersion medium contained in the cell G and the cell H is the same while the colors of the colorants of the dispersion medium are different, the sol transition temperatures and the gel transition temperatures can be made different by changing the mixing ratio of these, so that the recording medium of the present disclosure is obtained in some cases.

Thermoreversible Gelling Agent

As the thermoreversible gelling agent, it is suitable to use a thermoreversible gelling agent capable of converting the dispersion medium into a gel at the time of image browsing and image saving, and converting the dispersion medium into a liquid at the time of image recording at a temperature higher than the temperature for the image browsing and image saving. Further, as the thermoreversible gelling agent, a thermoreversible gelling agent having more excellent temperature responsiveness is preferable, and a thermoreversible gelling agent that converts the dispersion medium into a sol at once when the temperature becomes higher than a certain temperature, and converts the dispersion medium into a gel at once when the temperature becomes the certain temperature or lower, is more suitable.

Image browsing means a state where a user views image information recorded on the recording medium. Image saving means a state where image information is saved on the recording medium. In other words, the time of image browsing and image saving means a situation at a normal temperature and, for example, a state at temperatures of 10° C. or higher but lower than 40° C.

In the present disclosure, the state of gel means that the liquid dispersion has lost its fluidity. Accordingly, the mobility of the electrophoretic particles and/or magnetophoretic particles dispersed in the liquid dispersion is subdued and fixed. In the present disclosure, a gel is preferably elastic in terms of imparting flexibility to a recording medium. On the other hand, the state of liquid means that the dispersion medium has fluidity so that the electrophoretic particles and/or magnetophoretic particles dispersed in the liquid dispersion move freely. In the present disclosure, the liquid state preferably has a sufficiently low viscosity so as not to suppress the mobility of the electrophoretic particles and/or magnetophoretic particles.

The thermoreversible gelling agent forms a network structure by secondary bondings by hydrogen bonding, the van der Waals' force, hydrophobic interaction, electrostatic interaction, π-π interaction, etc. By incorporating the dispersion medium into the network structure, the dispersion medium is converted into a gel. On the other hand, the secondary bonding is easily cut by heating, so that it is considered that the dispersion medium is returned to a liquid by heating. The three-dimensional network structure is formed in such a manner that, for example, the thermoreversible gelling agent molecules self-aggregate due to hydrogen bonding to form fibrous aggregates by intermolecular interaction, and further, the fibrous aggregates grow due to the van der Waals' force and hydrophobic or electrostatic interaction, and fibrous aggregates intertwine with each other. By incorporating the dispersion medium molecules into the three-dimensional network structure, gelatinization of the dispersion medium progresses.

There is no specific limit to the thermoreversible gelling agent, which can be appropriately selected in accordance with particular applications. Specific examples of the thermoreversible gelling agent include, but are not limited to, organogel and hydrogel.

The organogel is a thermoreversible gelling agent that can turn an organic solvent or silicone oil serving as the dispersion medium into a gel. For this reason, when an organic solvent or silicone oil is used as the dispersion medium, organogel is suitable as the thermoreversible gelling agent.

Specific examples of organogels include, but are not limited to, 1,2,3,4-dibenzylidene-D-sorbitol, 12-hydroxy stearic acid, N-lauroyl-L-glutamic acid-α, γ-bis-n-butyl amide, spin labelized steroid, cholesterol derivatives, dialkyl phosphoric acid aluminum, phenolic cyclic oligomer, 2,3-bis-n-hexadesiloxane anthracene, cyclic depsipeptide, partially-fluorinated alkanes, cystine derivatives, bis(2-ethylhexyl)sulfo succinic acid sodium, triphenyl amine derivatives, butylolactone derivatives, quaternary ammonium salts, fluorinated alkylized oligomers, urea derivatives, vitamine H derivatives, glucone amide derivatives, cholic acid derivatives, L-alanine derivatives, L-isoleucine derivatives, L-valine derivatives, cyclic dipeptide derivatives, oligo(α-amino acid), cyclohexane diamine derivatives, 1,3,5-cyclohexane tricarbonic acid derivatives, double headed type amino acid derivatives, derivatives, barbituric acid derivatives, and triaminopyridine derivatives. These may be used alone or in combination of two or more thereof.

Moreover, a polymer or oligomer type thermoreversible gelling agent are known and useful.

A low molecular weight thermoreversible gelling agent is turned into a crystal while left for a long period of time depending on the structure thereof, which creates a problem of stability. By contrast, polymer or oligomer type thermoreversible gelling agents are suitable because these are not crystallized owing to the molecular weight distribution thereof or the movements of the flexuous chain thereof. Polymer or oligomer type thermoreversible gelling agents can be obtained, for example, by introducing a gelling component that induces gelation to a polymer component that prevents crystallization.

Since a thermoreversible gelling agent is used in the recording layer of the recording medium of the present disclosure, it is preferable that the thermoreversible gelling agent has excellent temperature responsiveness for sol-gel transition (promptly turn the dispersion medium into liquid as heated and immediately turns the dispersion medium into a gel as the temperature is returned to room temperature) and the thermoreversible gelling agent stably demonstrates features to prevent collapse of gel by crystallization, even after the sol-gel transition thereof is repeated. For this reason, the following gelling agents are particularly useful.

Since the thermoreversible gelling agent has to quickly form an associate by hydrogen bond first, the thermoreversible gelling agent preferably has an amide bond (—NHCO—) in the structure thereof and more preferably, multiple amide bonds. The mechanism of the thermoreversible gelling agent gelating a dispersion medium is the hydrogen bond formed between N—H and C═O of an amide bond. Formation of a gel with excellent temperature responsiveness depends on the reactivity of the hydrogen bond. Therefore, it is preferable that the thermoreversible gelling agent has an amide bond in its molecule.

In addition, the thermoreversible gelling agent preferably has a urethane bond (—NHCOO—) in its molecule. A thermoreversible gelling agent having a urethane bond improves the temperature responsiveness for sol-gel transfer of a dispersion medium in comparison with a thermoreversible gelling agent just having an amide bond. When a thermoreversible gelling agent has a single amide or urethane bond, the thermoreversible gelling agents themselves form a hydrogen bond. However, to quickly form a gel, it is preferable to contain multiple amide bonds and/or urethane bonds in the structure of the thermoreversible gelling agent. The more bonds, the more preferable. By having more amide bonds or urethane bonds, gelling capability is enhanced and response to sol-gel transfer becomes significantly quick, which is useful for the present disclosure.

In addition, the thermoreversible gelling agent more preferably has a siloxane bond in its molecule.

The siloxane bond has a structure in which silicon (Si) and oxygen (O) are alternately bonded. Examples of the thermoreversible gelling agent having a siloxane bond are as follows:

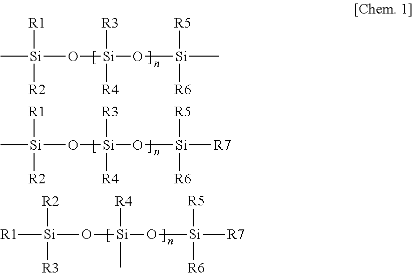

In the formulae above, R1 to R7 are each a C8-C20 alkyl group, and R1 to R7 may be the same or different to each other. A symbol “n” represents an integer of from 0 to 80.

The thermoreversible gelling agent having a siloxane bond is never or little crystallized and can enhance the stability of a gel. In addition, the gel tends to be softened, which is suitable for enhancing the flexibility of the recording medium of the present disclosure.

As the siloxane bond in the thermoreversible gelling agent becomes long, the gel becomes soft, and the sol-gel transition temperatures of the dispersion medium tend to become lower.

However, if the gel of the dispersion medium becomes excessively soft, the electrophoretic particles may not be easily fixed or safety may be lost. It is preferable that the length of the siloxane bond is properly controlled with respect to the sol-gel transition temperatures and flexibility of the dispersion medium designed for the recording medium.

A preferable length of the siloxane bond in the thermoreversible gelling agent is defined as follows. That is, it is preferable that the number of silicon atoms M of the siloxane bond in the molecule of the thermoreversible gelling agent and the total number N of the amide bonds (—NHCO—) and urethane bonds (—NHCOO—) in the molecule satisfy the following relation:

0.5≦M/N≦4.0

When the ratio M/N is less than 0.5, the sol-gel transition temperatures of the dispersion medium may be excessively higher than sol or gel transition temperature suitable for the rewritable recording medium, there is a possibility that the gel becomes unstable, or the gel becomes excessively hard and the flexibility becomes lower.

When the ratio M/N is greater than 4.0, there is a possibility that the sol-to-gel transition temperature becomes excessively lower than a sol-to-gel transition temperature suitable for a rewritable recording medium or the gel becomes excessively soft and the dispersion medium does not turn into a gel even at a normal temperature and the image retentiveness deteriorates.

In the present disclosure, the molecule of a thermoreversible gelling agent preferably has a long chain alkyl group having 8 or more carbon atoms and/or a long chain alkylene group having 8 or more carbon atoms. In order to grow associates formed by hydrogen bond of the amide bond or urethane bond of the thermoreversible gelling agent into fibrous form and further grow into a three-dimensional network structure, a structure is preferable in which associates easily interact with each other. It is considered that these long-chain alkyl group and long-chain alkylene group promote intermolecular interaction and contribute to the formation of the fibrous aggregates and three-dimensional network structure.

The number of carbon atoms in the long chain alkyl group is preferably from 8 to 20 and, the long chain alkylene group, from 8 to 12.

As described above, not all thermoreversible gelling agents can be used for the recording medium of the present disclosure. As for the present disclosure, it is suitable to select a thermoreversible gelling agent which can be used with a high insulating dispersion medium. Also, a suitable thermoreversible gelling agent is selected whether it has a sol-gel transition temperature suitable for the environment in which the recording medium is used and excellent temperature responsiveness to sol-gel transition (promptly turn the dispersion medium into a liquid as heated, and immediately turns the dispersion medium into a gel as the temperature is returned to room temperature) and can stably maintain its functionality without being crystallized and collapsing a gel, even after sol-gel transition thereof is repeated.

Particularly preferred examples of the thermoreversible gelling agents for use in the recording medium of the present disclosure are as follows. These are just examples, which are not limiting of the thermoreversible gelling agent for use in the present disclosure.

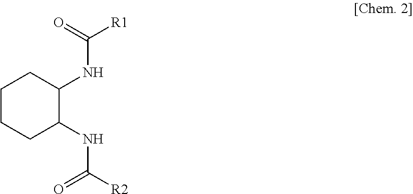

In the formulae above, R1 and R2 each, independently represent C8-C20 alkyl groups. In the formulae above, R1 and R2 can be the same or different.

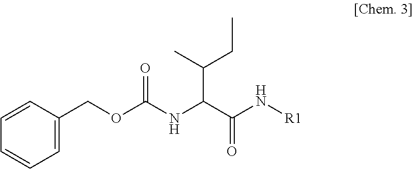

In the formula above, R1 is an alkyl group having 8 to 20 carbon atoms.

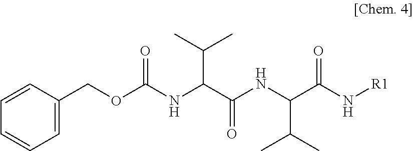

In the formula above, R1 is an alkyl group having 8 to 20 carbon atoms.

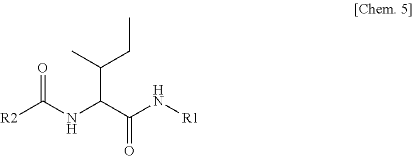

In the formulae above, R1 and R2 each, independently represent alkyl groups. The number of carbon atoms of the alkyl group is preferably from 8 to 20.

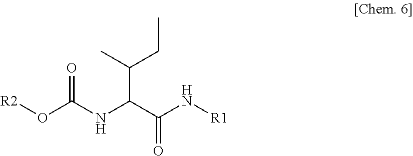

In the formulae above, R1 and R2 each, independently represent C8-C20 alkyl groups. The number of carbon atoms of the alkyl group is preferably from 8 to 20.

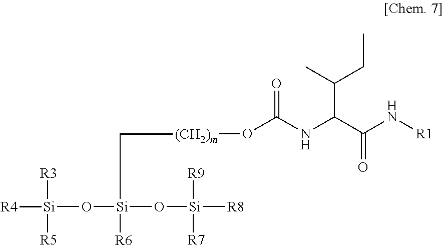

In the formulae above, R₁ represents an alkyl group having 8 to 20 carbon atoms. R3 to R9 each, independently represent hydrogen atoms, alkyl groups having 1 to 12, alkoxy groups having 1 to 12 carbon atoms, or aryl groups with or without substitution groups. R3 to R9 each, can independently be the same or different. “m” represents an integer of from 1 to 20.

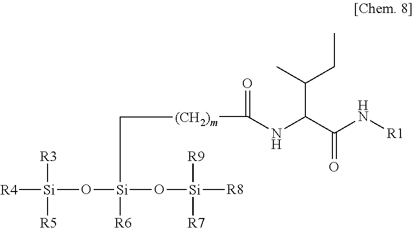

In the formulae above, R₁ represents an alkyl group having 8 to 20 carbon atoms. R3 to R9 each, independently represent hydrogen atoms, alkyl groups having 1 to 12, alkoxy groups having 1 to 12 carbon atoms, or aryl groups with or without substitution groups. R3 to R9 each, can independently be the same or different. “m” represents an integer of from 1 to 20.

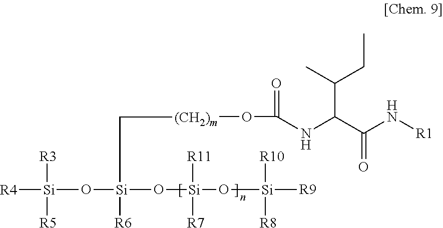

In the formulae above, R₁ represents an alkyl group having 8 to 20 carbon atoms. R3 to R11 each, independently represent hydrogen atoms, alkyl group having 1 to 12, alkoxy groups having 1 to 12 carbon atoms, or aryl groups with or without substitution groups. R3 to R11 each, can independently be the same or different. “m” represents an integer of from 1 to 20 and “n” represents an integer of from 1 to 80.

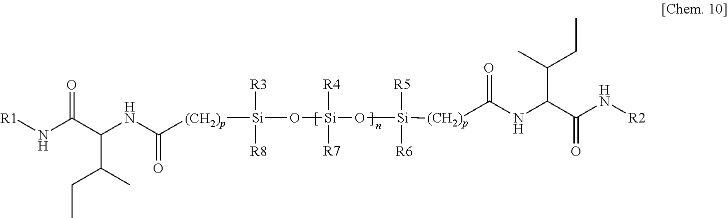

In the formulae above, R1 and R2 each, independently represent alkyl groups having 8 to 20 carbon atoms. R3 to R8 each, independently represent hydrogen atoms, alkyl group having 1 to 12, alkoxy groups having 1 to 12 carbon atoms, or aryl groups with or without substitution groups. R3 to R9 each, can independently be the same or different, “m” represents 0 or an integer of from 1 to 80 and “p” represents an integer of from 1 to 20.

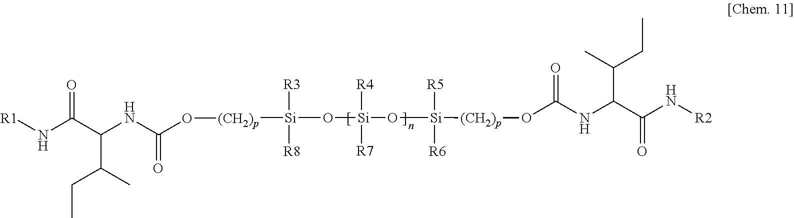

In the formulae above, R1 and R2 each, independently represent alkyl groups having 8 to 20 carbon atoms. R3 to R8 each, independently represent hydrogen atoms, alkyl groups having 1 to 12 carbon atoms, alkoxy groups having 1 to 12 carbon atoms, or aryl groups with or without substitution groups. R3 to R9 each, can independently be the same or different. “m” represents 0 or an integer of from 1 to 80 and “p” represents an integer of from 1 to 20.

The amount of the thermoreversible gelling agent contained in the image recording layer can be determined such that the dispersion medium is in gel form while browsing and saving images, for example, at room temperature, and the dispersion medium is in liquid form when an image is recorded (written), for example, at temperatures higher than the temperatures while browsing and saving images. The amount of the thermoreversible gelling agent in the image recording layer is preferably from 0.05% by mass to 50% by mass, more preferably from 0.1% by mass to 20% by mass, and even more preferably from 0.5% by mass to 10% by mass, to the amount of the dispersion medium. When the amount thereof is less than 0.05% by mass, the gelation of the dispersion medium is insufficient, which possibly impairs image retentiveness. When the amount thereof is greater than 50% by mass, the viscosity of the dispersion medium is possibly not sufficiently reduced, or insoluble matter easily remains, when the recording medium is heated. As a result, transfer of the electrophoretic particles and/or magnetophoretic particles is inhibited, thereby degrading the image quality.

The gel transition temperature and the sol transition temperature of the dispersion medium in the image recording layer are appropriately selected depending on the intended purpose without any limitation, but they are preferably from 40° C. to 120° C. and more preferably from 60° C. to 100° C. Furthermore, in terms of energy saving, it is furthermore preferably from 60° C. to 80° C.

The gel transition temperature and the sol transition temperature can be adjusted by appropriately selecting the kind and the amount of a dispersion medium and the kind and the amount of a thermoreversible gelling agent or mixing different thermoreversible gelling agents at an appropriate ratio. A thermoreversible gelling agent having a gel transition temperature and sol transition temperature lower than 40° C. poses no problem in a normal environment.

However, the image retentiveness tends to deteriorate as the recording medium is used outdoors exposed to direct sunlight or in a sun-heated car. In particular, unlike a PLD, the recording medium of the present disclosure is anticipated to be used in various environments including outdoors, so that image retentiveness has to be excellent in these environments. In order to stably use a recording medium in such an environment, the gelation and the liquefaction transfer temperature of a dispersion medium is preferably 60° C. or higher. When the gel transition temperature and the sol transition temperature surpass 120° C., the time taken to reach the temperature becomes longer and thus the recording speed and image quality are easily degraded.

However, the gel transition temperature and the sol transition temperature are not necessarily the same and hysteresis between the gel transition temperature and the sol transition temperature is allowed. When the sol transition temperature is higher than the gel transition temperature, images can be recorded in a wider temperature range, which is preferable. For example, in a case where the sol transition temperature is 80° C. whereas the gel transition temperature is 40° C., if a dispersion medium is once turned into a sol at 80° C. or higher, it is possible to record an image until it is gelated at 40° C. or lower. That is, when compared with a case in which the sol transition temperature is closer to the gel transition temperature, images can be recorded in a wider temperature range. When recording is conducted in a wider temperature range, contrast is improved, the degree of the non-uniformity of image density is reduced, and the image quality is improved. In addition, the printing speed is also improved and the designing flexibility is obtained with regard to arrangement of a heater, an electric field applicator, or a magnetic field applicator in a printer. In a case where a sol transition temperature is higher than a gel transition temperature, if the dispersion medium is once turned into a gel by cooling after recording an image, it has to be heated to 80° C. or higher for solation.

Accordingly, it is possible to maintain image retentiveness. Incidentally, the temperature relation between the sol transition temperature and the gel transition temperature depends on a dispersion medium and a thermoreversible gelling agent but is never or little affected by electrophoretic particles or magnetophoretic particles.

Here, the gel transition temperature or the sol transition temperature means temperatures at which a mixture of a dispersion medium and a thermoreversible gelling agent is turned from a sol (liquid) into a gel or from a gel into a sol (liquid) by the functionality of the thermoreversible gelling agent.

The method of making the sol transition temperature and/or the gel transition temperature of dispersion media contained in cells different depending on the color of electrophoretic particles and/or magnetophoretic particles or the combination of the colors has no specific limit but as described above, preferably a method of changing the kind of thermoreversible gelling agents contained, a method of changing the addition amount of thermoreversible gelling agents, and a method of changing dispersion media. Of these, the method of changing the kind and the addition amount of the thermoreversible gelling agent is described below.

The thermoreversible gelling agent being different means the chemical formula thereof is different, no matter how small it may be.

As described above, the thermoreversible gelling agent can be selected from various kinds, so that it is possible to provide the temperature different between the sol transition temperature and the gel transition temperature per cell. For example, if cells containing black particles and white particles are defined as cell I, cells containing red particles and white particles are defined as cell J and both contain a dispersion medium in common, it is possible to provide a temperature difference between the sol transition temperature and the gel transition temperature by using the thermoreversible gelling agent Gi for the cell I and the thermoreversible gelling agent Gj for the cell J.

However, although the thermoreversible gelling agents are different, it is possible that a sufficient temperature difference between the sol transition temperature and the gel transition temperature to control the display color is not obtained or the temperature difference is too large.

In such a case, a thermoreversible gelling agent is added to control the sol transition temperature and further the gel transition temperature, which is appropriate in some cases. For example, if cells containing white particles are defined as cell I, cells containing red particles are defined as cell J, and both contain a dispersion medium containing black particles in common and the same kind of thermoreversible gelling agent, the sol transition temperatures and the gel transition temperatures can be made different by changing the mixing ratio of these, so that the recording medium of the present disclosure can be obtained.

The method of determining the gel transition temperature and sol transition temperature of a dispersion medium containing a thermoreversible gelling agent can be any suitable method that is capable of determining the temperature at which transition from a sol to a gel or transition from a gel to a sol occurs.

For example, the following methods is appropriate.

For example, a method is suitable which uses differential scanning calorimeter (DSC). As for the device, a commercially available DSC analysis device is used.

When a sample containing a thermoreversible gelling agent is set and measured by DSC, the endothermic peak thereof is observed during a heating process, and, the exothermic peak, during a cooling process. The temperature of the endothermic peak in the heating process can be regarded as sol transition temperature and the temperature of the exothermic peak in the cooling process can be regarded as gel transition temperature. If the heating rate and the cooling rate are too fast, traceability of the heat deteriorates, resulting in a large error in the value. Therefore, the heating rate and the cooling rate are preferably slow, e.g., 5° C./min or less, more preferably 2° C./min or less.

Moreover, using dynamic mechanical analysis (DMA) is also suitable. As for the device, which is generally called as a viscoelasticity measuring device or rheometer, can be used for measurement. When a sample containing the thermoreversible gelling agent is set and measured by DMA, an area where the storage elastic modulus (G′) exceeds the loss elastic modulus (G″) and an area where the storage elastic modulus (G′) and the loss elastic modulus (G″) are crossed and the loss elastic modulus (G″) exceeds the storage elastic modulus (G′) are observed. Typically, the sample is regarded as the state of a gel in the region where G′ is larger than G″ (G′>G″) and is regarded as the state of a sol in the region where G′ is smaller than G″ (G′<G″). The point at which G′ and G″ are crossed during a heating process can be regarded as the sol transition temperature, and the point at which G′ and G″ are crossed during a cooling process can be regarded as the gel transition temperature. If the heating rate and the cooling rate are too fast, traceability of the heat deteriorates, resulting in a large error in the value. Therefore, the heating rate and the cooling rate are preferably slow, e.g., 5° C./min or less, more preferably 3° C./min or less. Moreover, in order to prevent vaporization of the dispersion medium in the state of a sol, a surrounding area of the plate to which the sample is set can be sealed with oil, which is useful in some cases.

Other various methods known in the art can be used to measure the sol transition temperature and the gel transition temperature of a dispersion medium, for example: a method using a tuning-fork vibration viscometer, in which an oscillator is vibrated in liquid at a constant frequency, to measure the value of electric current with which the viscous resistance of the oscillator becomes exciting-force, to thereby measure a viscosity; a method using a rigid pendulum rheometer, in which a measuring part, being a supporting point of a pendulum, on a sample, and a damping factor of the vibrations of the pendulum is measured; and a method including placing a colored liquid or object on a gel sample, and visually observing the change caused by heating.

Other Components

Examples of other components contained in the image recording layer include a dispersing agent and a surfactant. However, the aforementioned other components are not limited to these examples, and optionally contains other components.

Dispersing Agent

The dispersing agent can be any dispersing agent which is capable of enhancing dispersibility of the electrophoretic particles and/or magnetophoretic particles in the dispersion medium, preventing aggregation of electrophoretic particles and/or magnetophoretic particles and stably migrating the electrophoretic particles and/or magnetophoretic particles and appropriately selected depending on the intended purpose without any limitation. However, it is preferable to select a dispersing agent from those soluble to a dispersion medium and having a feature of preventing the electrophoretic particles and/or magnetophoretic particles from being aggregated to each other by electrostatic repulsion or steric hindrance by being adsorbed to the surfaces of the electrophoretic particles and/or magnetophoretic particles. In addition, the dispersion medium is preferably soluble in a non-polar solvent and a polymer dispersion medium is more preferable. This is because the dispersion stability of particles in a non-polar organic solvent system particularly depends on the steric effect of a polymer compound.

The polymer dispersing agent is preferably those having a basicity or acidity and more preferably those having a basicity. This is inferred such that, for example, in a case where a pigment, such as carbon black, is used as electrophoretic particles, a basic polymer dispersing agent is adsorbed to the surface of the pigment and acts as a positive charge-controlling agent, and demonstrates positively charging the pigment surface.

Specific examples of the polymer dispersing agent having a basicity include a polymer prepared from at least one monomer having a basicity (e.g., N-methylaminoethyl(meth)acrylate, N-ethylaminoethyl(meth)acrylate, N,N-dimethylaminoethyl(meth)acrylate, N,N-diethylaminoethyl(meth)acrylate, N,N-dibutylaminoethyl acrylate, N,N-di-tert-butylaminoethyl acrylate, N-phenylaminoethyl methacrylate, N,N-diphenylaminoethyl methacrylate, amino styrene, dimethylaminostyrene, N-methylaminoethylstyrene, dimethylaminoethoxystyrene, diphenylaminoethylstyrene, N-phenylaminoethylstyrene, 2-N-piperidylethyl(meth)acrylate, 2-vinylpyridine, 4-vinylpyridine, and 2-vinyl-6-methylpyridine) and at least one selected from the group consisting of alkyl ester of (meth)acrylic acid and aryl ester of (meth)acrylic acid.

As for the polymer dispersing agent having a basicity a commercial product can be used.

As for the commercial product thereof, preferred are SOLSPERSE 17000 (single polyester, anchoring site: basic group), SOLSPERSE 16000 (single polyester, anchoring site: basic group). SOLSPERSE 41000 (single polyester, anchoring site: acid), and SOLSPERSE 3000 (single polyester, anchoring site: acid), all manufactured by The Lubrizol Corporation. As another example, Disperbyk-2050, 2150, 160, 161, 162, 163, 164, 166, 167, and 182 (all manufactured by BYK Japan KK) can also be preferably used.

Surface Active Agent

The surfactant is added for the purpose of improving of the dispersion stability of the electrophoretic particles and/or magnetophoretic particles, obtaining a sufficient migration speed, and enhancing image retentiveness.

The surfactant is appropriately selected depending on the intended purpose without any limitation, but it is preferably a nonionic surfactant. If a surfactant other than nonionic surfactants is used, for example, an ionic surfactant is used, the ionic surfactant is adsorbed to the surfaces of the electrophoretic particles and magnetophoretic particles so that the behavior of the electrophoretic particles and/or magnetophoretic particles easily becomes unstable.

Specific examples of the nonionic surfactant include, but are not limited to, polyoxyethylene alkyl ether, polyoxyethylene alkyl allyl ether, polyoxyethylene alkylphenyl ether, polyoxyethylene glycol ester, polyoxyethylene fatty acid amide, polyoxyethylene fatty acid ester, polyoxyethylene polyoxypropylene glycol, glycerin ester, sorbitan ester, sucrose ester, polyoxyethylene ether of glycerin ester, polyoxyethylene ether of sorbitan ester, polyoxyethylene ether of sorbitol ester, fatty acid alkanol amide, amine oxide, polyoxyethylene alkyl amine, glycerin fatty acid ester, sorbitan fatty acid ester, polyoxyethylene sorbitan fatty acid ester, polyoxyethylene sorbitol fatty acid ester, and alkyl(poly)glycoxyde.

Of these, preferred are sorbitan trioleate, sorbitan laurate, sorbitan palmitate, sorbitan stearate, sorbitan tristearate, sorbitan oleate, sorbitan tribehenate, and sorbitan caprylate.

Configuration Example of Recording Medium

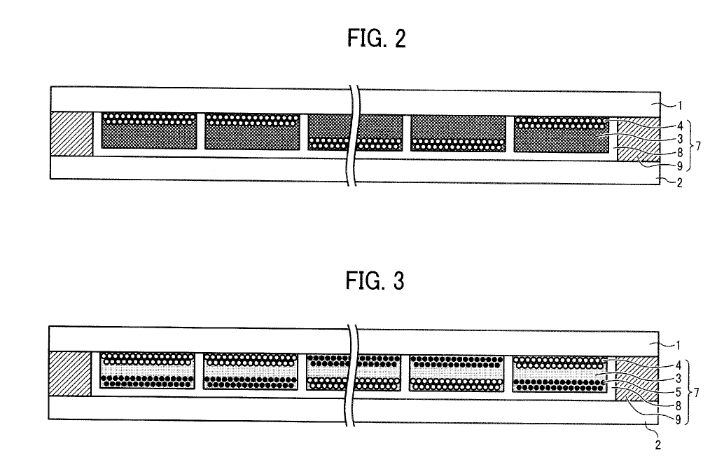

One example of the recording medium of the present disclosure using cells is described with reference to FIG. 2.

The recording medium illustrated in FIG. 2 contains a first substrate 1, a second substrate 2, and an image recording layer 7 sandwiched with these substrates (namely, enclosed with these substrates). The image recording layer 7 contains cells 8 spaced a constant gap, the cells 8 encapsulating white electrophoretic particles 4 and a colored dispersion medium 3 containing a thermoreversible gelling agent. As for the electrophoretic particles 4, particles of any color can be used other than white. Moreover, it is possible to provide a sealant 9 at the perimeter of the recording medium for the purpose of bonding the first substrate 1 with the second substrate 2 and sealing the image recording layer 7. Either or both of the first substrate 1 and the second substrate 2 contains a filler.

The recording medium illustrated in FIG. 3 contains a first substrate 1, a second substrate 2, and an image recording layer 7 sandwiched with these substrates (namely, enclosed with these substrates). The image recording layer 7 contains cells 8 provided certain intervals, and a transparent dispersion medium 3 containing white electrophoretic particles 4, and black electrophoretic particles 5, which is encapsulated in each cell. As for the electrophoretic particles 4 and 5, particles of any color can be used other than white or black. Moreover, it is possible to provide a sealant 9 at the perimeter of the recording medium for the purpose of bonding the first substrate 1 with the second substrate 2 and sealing the image recording layer. Either or both of the first substrate 1 and the second substrate 2 contains a filler.

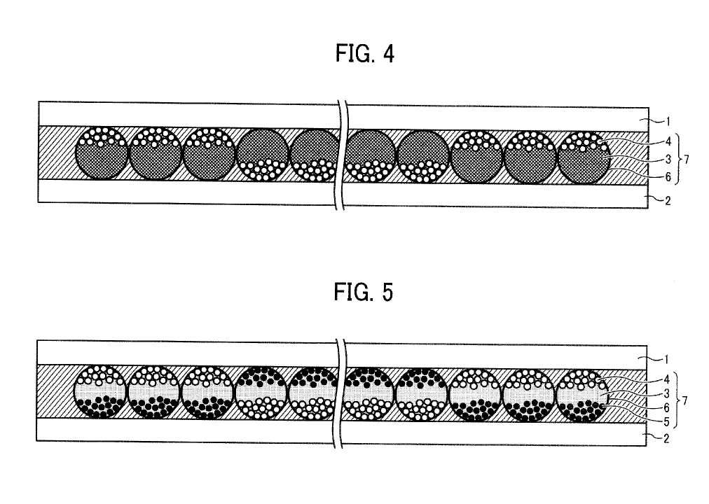

One example of the recording medium of the present disclosure using cells is described with reference to FIG. 4.

The recording medium illustrated in FIG. 4 contains a first substrate 1, a second substrate 2, and an image recording layer 7 sandwiched with these substrates (namely, enclosed with these substrates). The image recording layer 7 contains arranged multiple microcapsules 6, each containing a colored dispersion medium 3, white electrophoretic particles 4, and a thermoreversible gelling agent. As for the electrophoretic particles 4, particles of any color can be used other than white. Either or both of the first substrate 1 and the second substrate 2 contains a filler.

The recording medium illustrated in FIG. 5 contains a first substrate 1, a second substrate 2, and an image recording layer 7 sandwiched with these substrates (namely, enclosed with these substrates). The image recording layer 7 contains arranged multiple microcapsules 6, each containing a transparent dispersion medium 3 containing a thermoreversible gelling agent, white electrophoretic particles 4, and black electrophoretic particles 5. As for the electrophoretic particles 4 and 5, particles of any color can be used other than white or black. Either or both of the first substrate 1 and the second substrate 2 contains fillers.

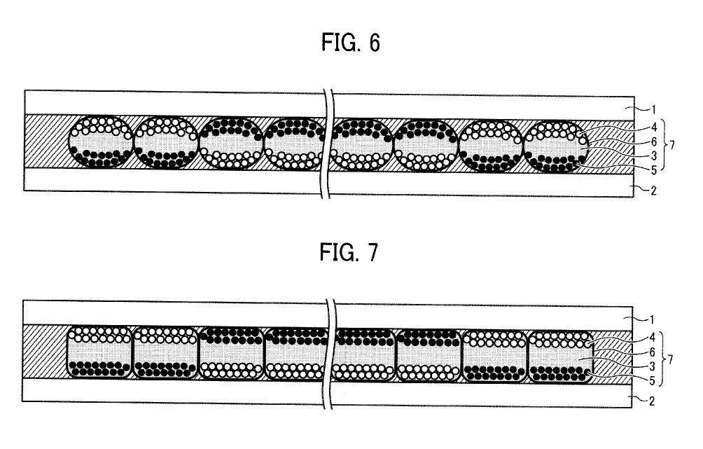

The average thickness of the image recording layer is appropriately determined depending on the intended purpose without any limitation and preferably 5 μm to 1,000 μm, more preferably 10 μm to 100 μm, and even more preferably 20 μm to 60 μm. When the thickness of the image recording layer is less than 5 μm, the contrast ratio tends to become low. When the thickness thereof is greater than 200 μm, the recording speed or resolution is reduced or a drive voltage has to be increased. Note that, the thickness of the image recording layer indicates thickness of the thickest part of the image recording layer. For example, as illustrated in FIGS. 6 and 7, in the case where a cross-section of the image recording layer 7 is not a true circle but, for example, a substantially circle or a polygon, the length of the longest part of the image recording layer along the thickness direction is the thickness of the image recording layer 7.

The average thickness of the recording medium of the present disclosure is appropriately selected depending on the intended purpose without any limitation, but it is preferably 15 μm to 1,200 μm, more preferably 30 μm to 600 μm, and even more preferably 50 μm to 260 μm.

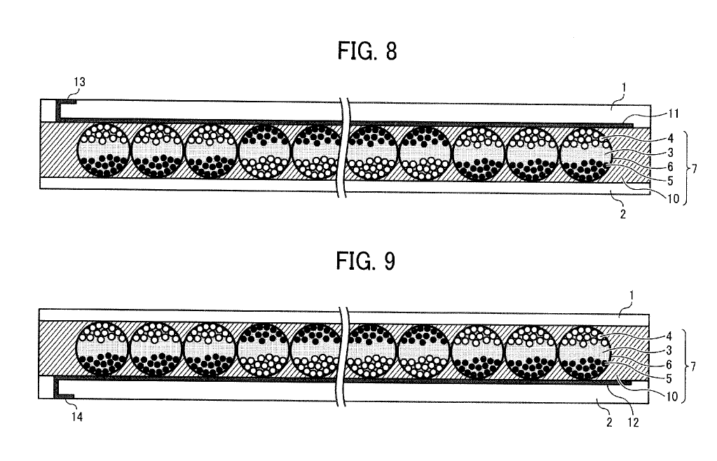

Moreover, it is possible and suitable that the recording medium of the present disclosure has a structure where an electric conductive layer is provided between the image recording layer and the substrate and the electric conductive layer is electrically connected with an electrode formed on the exterior of the recording medium. For example, FIG. 8 is a diagram illustrating an example of a recording medium having an electroconductive layer provided between one of the substrates and the image recording layer 7, that is, a first electric conductive layer 11 is provided between the first substrate 1 and the image recording layer 7 of the recording medium of FIG. 5.

The recording medium illustrated in FIG. 8 has the first substrate 1, the second substrate 2, and the image recording layer 7 provided between these substrates. The image recording layer 7 contains arranged multiple microcapsules 6, each containing a transparent dispersion medium 3 containing a thermoreversible gelling agent, white electrophoretic particles 4, and black electrophoretic particles 5 and the microcapsules 6 are fixed and insulated by a binder resin 10. The first electric conductive layer 11 is provided between the image recording layer 7 and the first substrate 1. Moreover, the first electric conductive layer 11 is electrically connected with a first electrode 13 formed on the surface of the recording medium. The second substrate 2 onto which an electric conductive layer is not formed is preferably made as thin as possible.

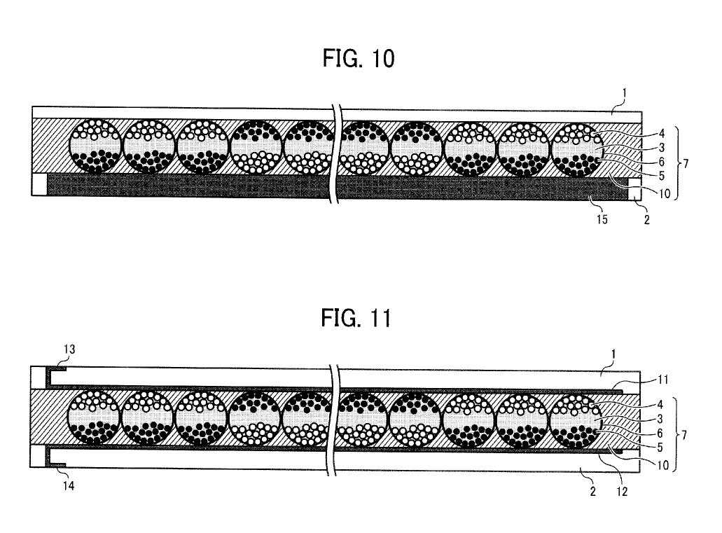

As another example of the recording medium of the recording medium illustrated in FIG. 8, a recording medium possibly has a structure as illustrated in FIG. 9, where a second electric conductive layer 12 is provided between the second substrate 2 and the image recording layer 7 and the second electric conductive layer 12 and an electrode 14 are electrically connected. Further, another recording medium illustrated in FIG. 9 possibly has a structure as illustrated in FIG. 10, where an electric conductive substrate 15 is used instead of the second substrate 2.

Moreover, a case where the electric conductive layer and the electrode are integratedly mounted is depicted in FIGS. 8 to 10, but the electric conductive layer and the electrode can be provided as separate devices.

In addition, FIG. 11 illustrates an example of the recording medium having electroconductive layers between one substrate and the image recording layer and between the other substrate and the image recording layer, in which the first electric conductive layer 11 is provided between the first substrate 1 and the image recording layer 7 of the recording medium of FIG. 5 and a second electric conductive layer 12 is provided between the second substrate 2 and the image recording layer 7 thereof.

The recording medium illustrated in FIG. 11 has the first substrate 1, the second substrate 2, and the image recording layer 7 provided between these substrates. The image recording layer 7 contains arranged multiple microcapsules 6, each containing a transparent dispersion medium 3 containing a thermoreversible gelling agent, white electrophoretic particles 4, and black electrophoretic particles 5 and the microcapsules 6 are fixed and insulated by a binder resin 10. The first electric conductive layer 11 is provided between the image recording layer 7 and the first substrate 1 and the second electric conductive layer 12 is provided between the image recording layer 7 and the second substrate 2. Moreover, the first electric conductive layer 11 is electrically connected with a first electrode 13 formed on one exterior of the recording medium and the second electric conductive layer 12 is electrically connected with a second electrode 14 formed on the opposite exterior of the recording medium.

Note that, “exterior of the recording medium” can be any area of the recording medium that is electrically connected to an electric field application device provided to an image recording device and indicates, for example, a surface, a back surface, and a side surface of the recording medium. Moreover, a case where the electric conductive layer and the electrode are integratedly mounted is depicted in FIG. 11 but the electric conductive layer and the electrode can be provided as separate devices.

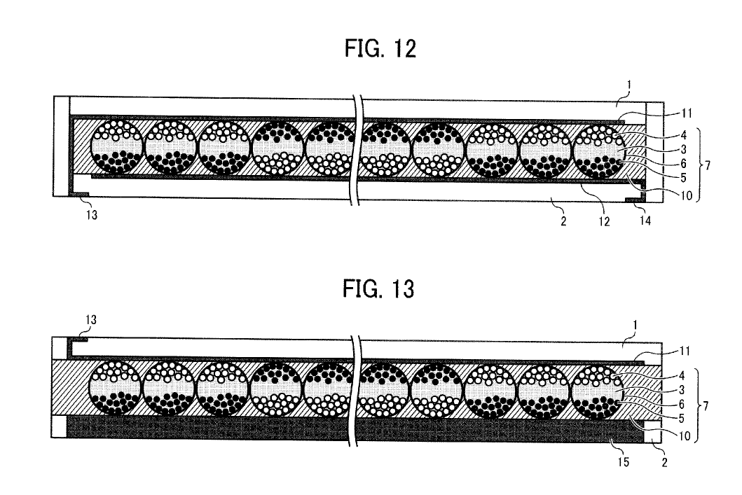

Moreover, as another example of the recording medium of FIG. 11, the first electrode 13 and the second electrode 14 can be provided on the same surface, as illustrated in FIG. 12.

As another example of the recording medium of the recording medium of FIG. 11, the recording medium possibly has the structure illustrated in FIG. 13.

The recording medium illustrated in FIG. 13 has the first substrate 1, the second substrate 15, and the image recording layer 7 provided between these substrates. The image recording layer 7 contains arranged multiple microcapsules 6, each containing a transparent dispersion medium 3 containing a thermoreversible gelling agent, white electrophoretic particles 4, and black electrophoretic particles 5 and the microcapsules 6 are fixed and insulated by a binder resin 10. The First electric conductive layer 11 is provided between the image recording layer 7 and the first substrate 1 and the first electric conductive layer 11 is electrically connected to the first electrode 13 formed in the exterior of the recording medium. As for the substrate (second substrate) provided on the opposite side of the recording medium, the electric conductive substrate 15 containing electroconductive fillers is provided, being electrically connected to the image recording layer 7.

Moreover, a case where the electric conductive layer and the electrode are integratedly mounted is illustrated in FIGS. 12 and 13, but the electric conductive layer and the electrode can be provided as separate devices.

Image Recording Device, Image Recording Method, and Image Recording Set

The image recording device of the present disclosure is used for recording images on the recording medium of the present disclosure and includes at least a heating device, an electric field application device and/or a magnetic field application device. The image recording device of the present disclosure preferably further has an image erasing device and furthermore other optional devices.

In the image recording method, the area to be heated of the image recording layer of the rewritable recording medium is smaller than, larger than, or equal to the area of the image recording layer of the recording tedium to which an electric field and/or magnetic field is applied.

In the case where the heated area of the image recording layer of the rewritable recording medium is smaller than the area of the image recording layer of the recording medium to which an electric field or magnetic field is applied, for example, used is a system where the electric field and/or magnetic field is applied to the entire area of the recording medium to record image patterns by heat. In the case where the heated area of the image recording layer of the rewritable recording medium is larger than the area of the image recording layer of the recording medium to which an electric field or magnetic field is applied, for example, used is a system where the entire area of the recording medium is heated to solate the dispersion medium therein, so that image patterns are recorded in the sol state by applying an electric field and/or magnetic field.

Furthermore, in the case where the heated area of the image recording layer of the rewritable recording medium is equal to the area of the image recording layer of the recording medium to which an electric field or magnetic field is applied, for example, used is a system where heat and electric field and/or magnetic field are applied to the area of the recording medium to which images are recorded.

The image recording set of the present disclosure contains at least the recording medium of the present disclosure and an image recording device and has other optional devices.

Image Recording Device

The image recording device of the present disclosure is used for recording images on the recording medium of the present disclosure and has at least a heating device, an electric field application device and/or a magnetic field application device. It preferably includes an image erasing device, and further optional devices. The heating device, the electric field application device and/or the magnetic field application device, and the image erasing device can be arranged in any convenient order in the image recording device and they can be arbitrarily provided.

The image recording method includes at least a heating step and an electric field applying step and/or magnetic field applying step, preferably an image erasing step, and other optional steps.

The image recording method can be suitably carried out by the image recording device. The heating step can be carried out by the heating device. The electric field applying step or magnetic field applying step can be carried out by the electric field application device or magnetic field application device. The image erasing step can be carried out by the image erasing device. The heating step, the electric field applying step and/or magnetic field applying step, and the image erasing step do not need to be performed in this order, and the order thereof can be appropriately set.

The image recording device is not integrated with the recording medium of the present disclosure and is a so-called external drive-type image recording device.

Heating Device and Heating Step

The heating device is appropriately selected depending on the intended purpose without any limitation, provided that it is a device capable of heating the recording medium to temperature equal to or higher than gelation (liquidization) temperature of the dispersion medium in the image recording layer of the recording medium.

The heating device is used differently in a case where the entire area of the image recording layer of the recording medium of the present disclosure is heated and a case where a part of the image recording layer is heated, depending on the image recording method. For example, the former is a case where an entire area of the image recording layer is heated to turn into a state of a sol, followed by applying an electric field and/or magnetic field to a part of the image recording layer to record an image, and the latter is a case where, after (or while) an electric field and/or magnetic field is applied to the entire area of the image recording layer, part of the image recording layer is heated and turned into a state of a sol, thereby recording an image. The sequence of the heating step and the electronic and/or magnetic field applying step can be the other way round. It is also suitable to apply heat and an electric field and/or magnetic field only to the area in which an image is recorded.

There is no specific limit to the heating method when heating the entire of an image recording layer. For example, various heaters are usable. In addition, a fixing device for use in electrophotographic copiers or printers can be suitably used as the heating device.

Specifically, examples thereof include a heat roller. The heating step is appropriately selected depending on the intended purpose without any limitation, provided that the recording medium of the present disclosure can be heated, and for example, the heating step can be carried out by the heating device.

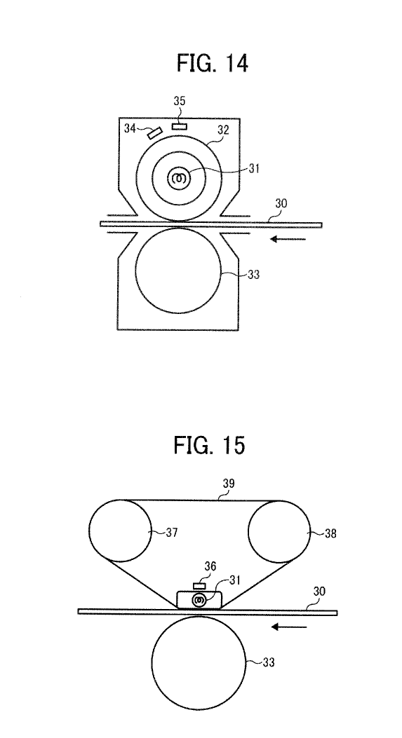

FIG. 14 illustrates one example of the heating device using a heat roller. The heating device of FIG. 14 contains a heat roller 32 having a heat source 31 inside, a pressure roller 33, a high speed response thermistor 34, and a thermostat 35 for preventing overheating. Examples of the heat source 31 include a halogen heater, and a ceramic heater.

The heating roller 32 preferably has a configuration in which Si rubber is covered on a core metal with high rigidity such as iron and SUS.

As the pressure roller 33, a coating with a thickness of approximately 100 μm of Si rubber, fluorine-contained rubber or fluorine resin is coated on a core metal for smoothly feeding and preventing twining of a transfer material.

In addition, it is preferable that a pressurizing arm is provided on an end portion of the pressurizing roller 33, and spring suspension is provided to allow a load to be applied between the pressurizing roller and the heating roller 32.

A method is also possible that the pressurizing roller 33 is a heat roller enclosing a heater so as to heat the recording medium from both of the recording surface side and the back surface side, and this is suitable to increase the recording speed of the rewritable recording medium 30.

As illustrated in FIG. 15, moreover, a device containing a belt-like form film roll 39 disposed in contact with the recording medium 30 of the present disclosure, and a heat source 31 fixed on the inner side of the film so as to face the recording medium 30 can be used.

This has advantages such as shortening the warm-up time and reducing the power consumption. In this heating device, the belt-like form film roll 39 is rotated by a roller 37 and a roller 38.

Moreover, the recording medium 30 is pressurized by the pressure roller 33. Furthermore, the temperature of the heat source 31 is controlled by a temperature sensor 36.

The heating device is, for example, an IH (Electromagnetic Induction Heater) type device. In the IH system, when a high-frequency power source (inverter) is connected to an exciting coil and a high-frequency current is supplied to the exciting coil, a high-frequency magnetic field is generated around an IH coil, and due to this magnetic field, an eddy current flows to a magnetic metal member and Joule heat is generated, whereby performing heating.

On the other hand, for recording an image on the recording medium to which an electric field and/or a magnetic field is applied by heating a part of the image recording layer, a thermal head can be used.

A thermal head is to record an image on a recording medium by selectively applying a potential to aligned heat resisting elements to generate heat according to image data.

The thermal head can be appropriately selected from conventional thermal heads used for a thermosensitive printer, such as a direct thermal printer, and a thermal transfer printer, provided that it can heat the recording medium to temperature equal to or higher than the sol transition temperature.

The thermal head is light in weight and small in size, requires low consumption power, and is capable of straight pass, hence is very suitable as an image forming device used for the recording medium of the present disclosure.

The recording medium of the present disclosure uses the thermoreversible gelling agent, and therefore temperature responsiveness of the recording medium to sol-gel transition is high, and sol-gel transition of the dispersion medium can be sufficiently induced by the thermal head.

Moreover, because of the points as mentioned, image formation can be performed not only by an electric field, but also by heat, it is very suitable and useful.

As another method, moreover, a method using laser light can be applied. In this method, heating is performed using thermal energy of laser light, which is a non-contact heating system different from recording by a thermal head. With this method, recording can be performed from a position distant from the recording medium.

As other heating devices, for example, a microwave and an IH heater can be used. Any heating device that can heat a recording medium can be used

Electric Field or Magnetic Field Application Device and Electric Field or Magnetic Field Applying Step

The electric field application device or magnetic field application device is appropriately selected depending on the intended purpose without any limitation, provided that it is a device to apply an electric field, or a magnetic field, or a combination thereof to the recording medium of the present disclosure.

The electric field applying step or magnetic field applying step is appropriately selected depending on the intended purpose without any limitation, provided that it is a step containing applying an electric field and/or a magnetic field to the recording medium of the present disclosure. For example, the electric field applying step or magnetic field applying step can be performed by the electric field application device or magnetic field application device.

Device to Apply Electric Field

The electric field application device is used differently in the case where an electric field is applied to the entire area of the image recording layer of the recording medium of the present disclosure, and in the case where an electric field is applied to a part of the image recording layer, depending on the image recording method.

The former is a case where, after (or during) an electric field is applied to the entire area of the image recording layer, an image is formed by the heating device, and the latter is a case where, after an entire area of the image recording layer is heated by the heating device, an electric field is applied to a part of the image recording layer to record an image.

As for a device to apply an electric field to an entire area of the image recording layer of the recording medium, various chargers or dischargers are used, but such device is particularly limited as long as it is capable of applying an electric field.

Examples thereof include a corona charger, a roller charger, a brush charger, a blade charger, and a solid discharger.

The corona charger is a member that charges the rewritable recording medium by applying a high voltage to a wire, ionizing the air around the wire, and moving the ions to the surface of the rewritable recording medium, and has advantages of non-contact, high-speed followability, and high charge uniformity.

The corona charger is formed by laying discharge wires such as tungsten wires and stainless steel wires with a diameter of 40 μm to 100 μm in 1 row to 3 rows in a shield case provided with corrosion resistance, and gold-plated discharge wires are used for reducing discharge unevenness in many cases.

As the corona charger, there are a corotron type without a grid and a scorotron type using metal thin wires or punching metal as a grid (control grid or suppressor grid). The discharge state is different between the case where a positive voltage is applied to the discharge wire and the case where a negative voltage is applied to the discharge wire, and when a positive voltage is applied, discharge occurs uniformly along the wire, and on the other hand, when a negative voltage is applied, discharge becomes point-like.

Therefore, when a positive voltage is applied, charging becomes substantially uniform even without a grid, and on the other hand, when a negative voltage is applied, charge unevenness assuming linear shading occurs without a grid, so that a scorotron type provided with a grip is preferable for uniform charging.

The roller charger is electrically connected to or provided adjacent to the recording medium of the present disclosure, and can charge an entire surface of the recording medium while rolling with respect to the movement of the recording medium. The roller charger is typically composed of two layers of an elastic layer and a top layer provided on a core metal.

Particularly for the elastic layer, for example, hydrin rubber or urethane rubber is used. A resistance control material such as carbon, graphite, active carbon fiber, and an ion electroconductive material is dispersed in these kinds of rubber to control the volume resistivity within the range of from 10⁵ Ω·cm to 10⁸ Ω·cm. The roller charger produces less ozone and NOₓ and allows setting of a low applied voltage, so that it is useful to reduce power consumption.

Moreover, it is also possible to use an application device, other than a charger utilizing discharge. Such application device is particularly suitably used for a recording medium, in which an electric conductive layer is provided between a substrate and an image recording layer, or an electric conductive substrate is used as a substrate. Use of these recording mediums is particularly preferable because driving voltage can be significantly reduced and it obviates the need of a charger utilizing discharge, which it particularly preferable in the present disclosure.

In a case of the recording medium in which an electric conductive layers or electric conductive substrates are provided on both surfaces of the image recording layer, an electric field can be applied thereto which has a voltage equal to the difference between the voltage applied to the electric conductive layer or electric conductive substrate provided at the side from which the recording medium is viewed and the voltage applied to the electric conductive layer or electric conductive substrate provided at the opposite side to the side from which the recording medium is viewed.

For example, an electric field of 100 V can be applied to the image recording layer by applying voltage of 100V to the electric conductive layer provided at the side from which viewed, through an electrode of the recording medium electrically connected with the electric conductive layer, and electrically connecting the electrode, which is electrically connected with the electrically conductive layer provided at the opposite side to the side from which viewed, with earth. The reverse connection thereof can apply an electric field of −100 V to the image recording layer.

In this case, as for the application device, any device can be used, as long as it is electrically connected to an electrode or electric conductive substrate, and is capable of applying an electric field to the image recording medium. For example, a brush-like form or roller-like form member having electric conductivity is preferably used. Specifically, a brush formed of electric conductive fibers or metal plating, or a rubber formed of electric conductive rubber or metal can be used.

The device to apply a part of the image recording layer of the recording medium of the present disclosure to form an image is appropriately selected depending on the intended purpose without any limitation, provided that it is capable of forming a latent electrostatic image, and can form an image by applying an electric field to the recording medium. As for a system for forming the latent electrostatic image, an electrophotographic system, and an ion irradiating system have been known, and these systems can be particularly effectively used in the present disclosure. In order to apply an electric field, a counter electrode is provided at the position facing the image forming device via the recording medium.

Electrophotographic Image Forming Device

The electrophotographic application device is appropriately selected depending on the intended purpose without any limitation, and examples thereof include a device to charge an image bearer, and then exposing the image bearer to light corresponding to an image pattern to form a latent electrostatic image on the surface of the image bearer.

The recording medium of the present disclosure can be recorded by bringing the recording medium into contact with the surface of the image bearer on which a latent electrostatic image has been formed.

The electrophotographic image forming device includes at least an image bearer, a charger, and an exposing device, and may further have other members, such as a diselectrification device, if necessary. In order to apply an electric field to the recording medium of the present disclosure, a counter electrode is provided at the position facing the image bearer serving as the image forming device via the recording medium of the present disclosure.

Image Bearer

There is no specific limit to the selection of the image bearer. Any image bearer that can form a latent electrostatic image can be suitably used. For example, it is appropriate to use an image bearer having a single-layer photosensitive layer formed by intermingling a charge generating material and a charge transporting material, provided on an electric conductive substrate formed of an aluminum or nickel element tube or a belt or a laminate image bearer, in which a charge generating layer and a charge transporting layer are laminated. Further, the image bearer is optionally of a high resistant image bearer, in which a protective layer is provided at a top surface thereof.

The image bearer can be used both by positively charged and by negatively charged. As there are more variations of hole transporting materials than those of electron transporting materials, a negative charging system (in this case, black electrophoretic particles are positively charged) is preferable in view of electrostatic properties. However, a positive charging system can be used in the case of the single-layer image bearer, as electron transportation and hole transportation are possible.

Charger

The charger is appropriately selected depending on the intended purpose without any limitation, provided that it is capable of charging the image bearer. Examples of the charger include a corona charger, a roller charger, a solid discharger, and a brush charger. Among them preferred are a corona charger, and a roller charger. Of these, a corona charger and a roller charger are preferable.

Exposing Device

The exposing device is appropriately selected depending on the intended purpose without any limitation, provided that it is capable of forming a latent electrostatic image on a surface of the image bearer, and examples thereof include a semiconductor laser (LD), a light emitting diode (LED), and an electroluminescence (EL). Of these, a semiconductor laser (LD) and a light emitting diode (LED) are preferable. Among these, light emitting diodes (LED) and semiconductor lasers (LD) are commonly used.

Diselectrification Device

The diselectrification (discharging) unit is appropriately selected depending on the intended purpose without any limitation, provided that it is capable of totally erasing the latent electrostatic image formed on the surface of the image bearer. Specific examples thereof include, but are not limited to, a semiconductor laser (LD), a light emitting diode (LED), an electroluminescence (EL), a fluorescent light, a tungsten lamp, and a halogen lamp. Of these, a light emitting diode (LED) is preferable.

Other Devices

Examples of the aforementioned other devices include a cleaning device and a lubricating substance application device.

The cleaning device is used for the purpose of removing foreign matter and discharge product deposited on the surface of the image bearer. The cleaning device is appropriately selected depending on the intended purpose without any limitation, and examples thereof include a blade, and a brush. The cleaning device is preferably disposed to be in contact with the image bearer.

The lubricating substance application device is used for the purpose of enhancing lubricity of the surface of the image bearer or removing a discharge product in combination with the cleaning device.

The lubricating substance application device is appropriately selected depending on the intended purpose without any limitation, and an example thereof include a brush. The lubricating substance application device is preferably disposed to be in contact with the image bearer and a solid lubricating substance. In a case where the lubricating substance application device is a brush, the lubricating substance is applied to the surface of the image bearer by rotating the brush.

Examples of the lubricating substance include wax, a fluorine-containing resin, a silicone resin, a poly-olefin-based resin, and a fatty acid metal salt. Of these, a fatty acid metal salt is preferable, and zinc stearate is more preferable.

Counter Electrode

The counter electrode is provided at the position opposite to the image bearer to place the recording medium of the present disclosure between the counter electrode and the image bearer. A material of the counter electrode is appropriately selected depending on the intended purpose without any limitation, provided that it conducts electricity, and examples thereof include platinum, gold, silver, copper, aluminum, zinc, nickel, titanium, and bismuth, alloys of these metals and carbon.

Since it is suitable to enhance the attachability between the counter electrode and the rewritable recording medium, for example, a conductive roll member with elasticity is preferably used as the counter electrode.

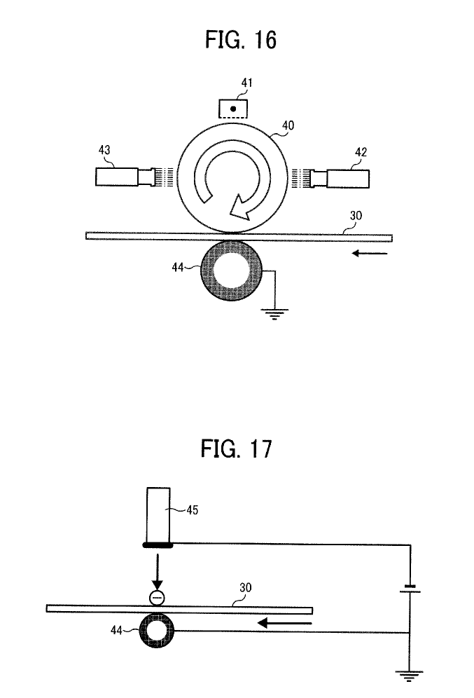

FIG. 16 is a diagram illustrating an example of an image forming device using an image hearer in the image recording device.

At the recording side of the recording medium 30 of the present disclosure, an image bearer 40 is provided to be in contact with the recording medium 30. At the back surface side of the recording medium 30, a counter electrode 44 is provided to at the position opposite to the image bearer 40 to place the recording medium 30 between the counter electrode 44 and the image bearer 40. In the surrounding area of the image bearer 40, provided are at least a charger 41 to charge the image bearer 40, an exposing device 42 to form a latent electrostatic image on a surface of the image bearer 40, and a diselectrification device 43 to erase the latent electrostatic image on the surface of the image bearer 40.

Ion Irradiation Type Image Forming Device

The ion irradiation type application device includes, for example, an ion flow generating section generally made of a discharge body, an electrode that controls a generated ion flow, and an opening for releasing an ion flow.

The flow volume of ions generated in the ion flow generating section is controlled by an electric field.

With the ion irradiation type, under an atmosphere in which ion generation is possible such as in the atmosphere, a latent electrostatic image can be directly formed by irradiation of ions generated by discharge from a discharge electrode, so that an image can be directly recorded on the recording medium of the present disclosure.

As the ion irradiation type, for example, JP-3725092-B1 (JP-2003-326756-A) describes a heating discharge type in which discharge is generated by selectively heating discharge electrodes in a state where a voltage (discharge control voltage) that does not generate discharge only by being applied to the discharge electrodes but generates discharge by heating is applied. This type includes discharge electrodes and heating elements disposed corresponding to the respective discharge electrodes, and discharge is not generated only by applying a voltage to the discharge electrodes, and discharge is generated by heating. Therefore, ion generation can be controlled by the presence/absence of heating elements, and lower-voltage driving, cost reduction, and downsizing of the device are realized.

A specific example of the ion irradiation type application device is an ion irradiation head having the aforementioned mechanism. The ion irradiation head contains a discharge body, and optionally a heating member and other members. Moreover, a counter electrode is provided at the position opposite to the ion irradiation head via the recording medium of the present disclosure.

Since image recording to the recording medium of the present disclosure is realized by heating and liquidizing the dispersion medium of the image recording layer, the aforementioned system, in which heating is performed during image recording, is very suitable for the present disclosure. That is, this image recording method is capable of matching the area of the image recording layer of a rewritable recording medium to which an electric field is applied with the area of the image recording layer of a rewritable recording medium to which heat is applied.

Therefore, in this method, this irradiation device (ion irradiation head) serves as a heating device and an electric field application device, which is advantageous to reduce the cost, power consumption, and the size of a device.

FIG. 17 is a diagram illustrating one example of the ion irradiation type image forming device.

In FIG. 17, at the position opposite to the ion irradiation head 45, a counter electrode 44 is provided to as to be in contact with the back surface of the recording medium 30. The ion irradiation head 45 is provided in contact with or adjacent to the recording surface of the recording medium 30. Inside the ion irradiation head 45, a discharger and optionally a heating member are provided. In the case of heating discharge system, a voltage is applied to a region in which discharge is generated by heating, and ion irradiation is carried out by temperature control by using the heating member.

Ions that passed through the opening of the ion irradiation head 45 are attached to the recording medium 30 according to an electric field formed between the ion irradiation head 45 and the counter electrode 44, thereby recording an image.

Device for Forming Image by Applying Magnetic Field

Similar to the application device, the magnetic field application device is used differently in the case where a magnetic field is applied to an entire area of the image recording layer of the recording medium of the present disclosure, and in the case where a magnetic field is applied to a part of the image recording layer, depending on the image recording method.

The former is the case where an image is formed by the heating device, while applying a magnetic field to the entire area of the image recording layer, and the latter is a case where, after the entire area of the image recording layer is heated by the heating device, a magnetic field is applied to a part of the image recording layer to record an image.

The magnetic field application device to apply a magnetic field to an entire surface of the image recording layer of the recording medium is preferably a magnet, in particular, a permanent magnet such as an alnico magnet, ferrite magnet, neodymium magnet, and samarium-cobalt magnet, or electromagnet, and particularly preferably an electromagnet. The electromagnet is formed by winding a coil around a ferromagnetic iron core with high magnetic permeability, and when a current is supplied to the coil, due to its magnetic field, the iron core is magnetized and becomes a magnet, and when the current is cut off, the iron core returns to an unmagnetized state.

On the other hand, the magnetic field application device to apply a magnetic field to a part of the image recording layer of the recording medium is appropriately selected depending on the intended purpose without any limitation, provided that it can form a latent magnetic image, and can form an image by applying a magnetic field of the recording medium.

Examples thereof include a magnetic head to be used for a magnetography magnetic printer.

Magnetic Head

The magnetic head is enabled to form a latent magnetic image when leakage magnetic flux is generated from the magnetic pole tip end portion by supplying a current to the coil of each channel. By scanning the recording medium of the present disclosure with the magnetic head, magnetophoretic particles of the recording medium are made migrate, and an image is recorded on the recording medium.

However, as the magnetic head, there are a multi-channel type and a full-line type, and a full-line type including aligned multichannel heads enables high-speed recording without the need of scanning of the heads. The material of the head is preferably a soft magnetic material to be used for a high-permeability core. The soft magnetic material is, for example, a high-permeability material with low coercivity and high saturation flux density such as Fe—Si—B—C amorphous alloy, FeP, permalloy (NiFe alloy), FeCoP, CoP, FeB, FeBSi, and silicon steel.

The magnetic printer is capable of forming a latent magnetic image on a latent magnetic image bearer by using a magnetic head, and in the present disclosure, is also capable of performing recording by bringing the recording medium according to the present disclosure into contact with the latent magnetic image bearer on which a latent magnetic image is formed.

It is possible to use an application device and a magnetic field application device in combination, as the image forming device. A multi-color printing can be realized by using the application device and the magnetic field application device in combination, using electrophoretic particles and magnetophoretic particles, colors of which are different, in the recording medium of the present disclosure.

Image Erasing Device and Image Erasing Step

The image erasing device is appropriately selected depending on the intended purpose without any limitation, provided that it is to apply an electric field, or a magnetic field, or a combination thereof to the recording medium of the present disclosure to erase the image recorded on the recording medium.

The image erasing step is appropriately selected depending on the intended purpose without any limitation, provided that it contains applying an electric field, or a magnetic field, or a combination thereof to the recording medium of the present disclosure to erase the image recorded on the recording medium. For example, the image erasing step can be carried out by the image erasing device.

Device for Erasing Image by Applying Electric Field

The device for erasing an image by applying an electric field is appropriately selected depending on the intended purpose without any limitation, and examples thereof include an image erasing device having a counter electrode and a charger or a discharger. Specifically, the application device to apply an electric field to an entire surface of the image recording layer of the recording medium of the present disclosure, such as a corona charger, a roller charger, and a solid discharger is also effectively used as the image erasing device.

Examples of the counter electrode include the counter electrode mentioned in the descriptions of the electrophotographic image forming device.

Device for Erasing Image by Applying Magnetic Field

The device for erasing an image by applying a magnetic field is appropriately selected depending on the intended purpose without any limitation. For example, the magnetic field application device to apply a magnetic field to an entire surface of the image recording layer of the recording medium of the present disclosure, such as permanent magnet, and electromagnet, is also effectively used as the image erasing device.

By scanning the rewritable recording medium or the permanent magnet in a state where the permanent magnet is brought into contact with the recording surface and/or the back surface of the recording medium, a recorded image can be totally erased.

The electromagnet is capable of controlling its magnetic force by means of turning ON/OFF of current supply, so that for example, a head including aligned electromagnets is provided, and the head is scanned with respect to the entire surface of the recording medium in a state where the current supply is turned ON, whereby totally erasing a recorded image.

Other Device and Other Process

Examples of the aforementioned other devices include a cooling device.

Examples of the aforementioned other steps include a cooling step.

Cooling Device and Cooling Step

The cooling device is appropriately selected depending on the intended purpose without any limitation, provided that it is a device capable of cooling the image recording layer of the recording medium of the present disclosure to temperature equal to or lower than the gel transition temperature thereof. Examples of the cooling device include a cooling fan, a cooling roller, and a cooling belt. Examples of the cooling device include a cooling fan, a cooling roller, and a cooling belt.

The cooling step is appropriately selected depending on the intended purpose without any limitation, provided that it is a step containing cooling the image recording layer of the recording medium of the present disclosure to temperature equal to or lower than the gel transition temperature thereof. For example, the cooling step can be carried out by the cooling device.

By the cooling device and the cooling step, the dispersion medium is turned into a gel soon after image recording, and image defects can be prevented, so that higher image quality is realized.

The image forming device of the set of the image recording set of the present disclosure includes at least a heating device and an electric field application device and/or a magnetic field application device and preferably an optional device of an image erasing device.

It is possible to combine at least two of the heating device, the electric field application device and/or the magnetic field application device, and the image erasing device as a single device, which is advantageous to reduce the cost, power consumption, and the size of a device.

Specifically, it is possible to perform image formation while heating, using the heating device and the application device in combination. For example, the ion irradiation head is provided with a heating member, or a drum heater is mounted on the image bearer capable of forming a latent electrostatic image.

It is also possible that the image erasing device and the application device are combined so that image recording is performed subsequently to total image erasing. For example, after totally erasing the image on the recording medium of the present disclosure by the application device, an image can be used by means of the same application device.

Similarly, it is also possible to combine the heating device, the electric field application device and/or magnetic field application device, and the image erasing device. For example, an image on the recording medium of the present disclosure is erased by initially outputting a solid pattern on the entire surface of the recording medium by the image bearer equipped with a drum heater as the heating member, followed by outputting an image pattern.

As described above, as for the image recording device of the image recording set of the present disclosure, the heating device, the image erasing device, the electric field application device and/or the magnetic field application device can be combined for use, and all combinations are within the scope of the present disclosure.

Each of the heating device, the image erasing device, and at least one of the electric field application device and the magnetic field application device provided can be plural in number.

In particular, by installing multiple the heating devices, the image quality may be improved. For example, an image is stably formed in any temperature environment by maintaining the temperature of the recording medium of the present disclosure with multiple the heating devices from the time when the recording medium is passed the first heating device to the time when an image is recorded. In the case where an image bearer is used as the image forming device, particularly, gelation of the dispersion medium may be started when the recording medium, which has been heated by the heating device in advance, is in contact with the image bearer, if the image bearer serving as the image forming device is cold. Therefore, it may be suitable to provide a drum heater serving as the heating member to the image bearer to maintain the temperature of the recording medium high until image recording is completed.

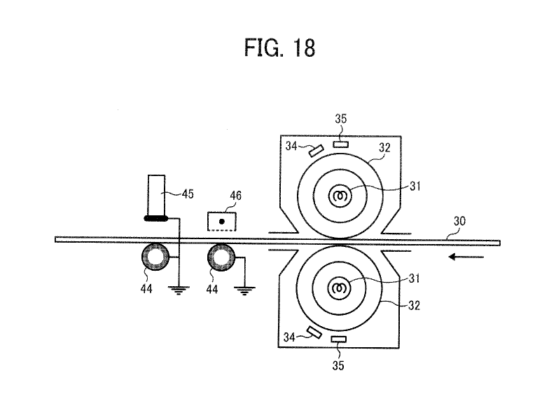

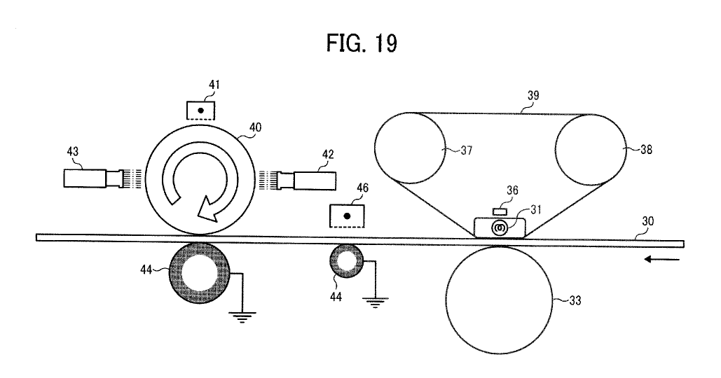

One example of the electrophoretic image recording method using the recording medium of the present disclosure is explained with reference to FIGS. 18 and 19. However, the present disclosure is not limited to these examples.

The image recording device depicted in FIG. 18 contains a heating device equipped with heating rollers 32 each containing a heat source 31 respectively provided with respect to both a recording surface and back surface of the recording medium 30 of the present disclosure, an image erasing device 46 to charge an entire recording surface of the recording medium 30 by a corona charger to erase all the recorded image, an image forming device to form an image on the recording medium 30 using an ion irradiation head 45, and a counter electrode 44, which is provided to electrically connected with the back surface of the recording medium 30 when the recorded image is formed or all erased. The heating device further contains a high speed response thermistor 34 and a thermostat 35.

The image recording device depicted in FIG. 19 contains a heating device to heat the recording medium 30 through a belt-like form film roll 39 that is suspended around and provided in contact with a heat source 31, an image erasing device 46 to charge an entire recording surface of the recording medium 30 by means of a corona charger to erase the recorded image, an image forming device containing an image bearer 40 to which a latent electrostatic image can be repeatedly formed by means of a charger 41, an exposing device 42, and a diselectrification device 43, and a counter electrode 44, which is provided to electrically connected with the back surface of the recording medium 30 when the recorded image is all erased and an image is formed. In the heating device, the belt-like form film roll 39 is rotated by a roller 37, and roller 38. Moreover, the recording medium 30 is pressurized by the pressure roller 33. Furthermore, the temperature of the heat source 31 is controlled by a temperature sensor 36.

As illustrated in FIGS. 18 and 19, as the recording medium 30 is heated by the heating device, the dispersion medium contained in the recording medium is turned into a liquid by a function of the thermoreversible gelling agent contained in the dispersion medium, so that the electrophoretic particles dispersed in the dispersion medium are allowed to move.

Next, uniform voltage is applied to the entire recording surface of the recording medium 30 by the image erasing device 46 to erase all the recorded image on the recording medium 30, so that the electrophoretic particles, which contribute to image formation, move to the opposite side of the image recording layer to the side thereof from which it is viewed.

In the case where electrophoretic particles for constituting the background of an image are contained, these electrophoretic particles are moved to the side of the image recording layer from which it is viewed. In the case where positively charged black electrophoretic particles are contained in the dispersion medium, for example, the black electrophoretic particles are moved to the opposite side to the side thereof from which it is viewed by applying positive charge by the image erasing device 46. In the case where negatively charged white electrophoretic particles are contained as well as the black electrophoretic particles, the black electrophoretic particles are moved to the opposite side to the side thereof from which it is viewed by applying positive charge and the white electrophoretic particles are moved to the side from which it is viewed, by applying positive charge by the image erasing device 46. Subsequently, a latent electrostatic image corresponding to an image pattern is formed on the recording medium 30, to thereby record the image pattern on the recording medium 30.

In the case where an image forming device to form a negatively charged latent electrostatic image in an imaging area is used, for example, the positively charged black electrophoretic particles are moved to the side to be viewed, and no movement of the particles occurs in non-imaging area, so that a black image pattern is recorded on the recording medium 30.

Thereafter, once the recording medium 30 is cooled to room temperature, the dispersion medium in the recording medium 30 is turned into a state of a gel by a function of the thermoreversible gelling agent, so that the electrophoretic particles contained in the dispersion medium cannot move, and the dispersion medium turns white (e.g., turns cloudy).

As a result, the imaging area in which the black electrophoretic particles have moved to the side to be viewed is displayed in black, and other area is displayed in white, to thereby form an image. Moreover, the formed image is stably maintained even when stimuli is externally applied over a long period, as the dispersion medium is converted into a gel.

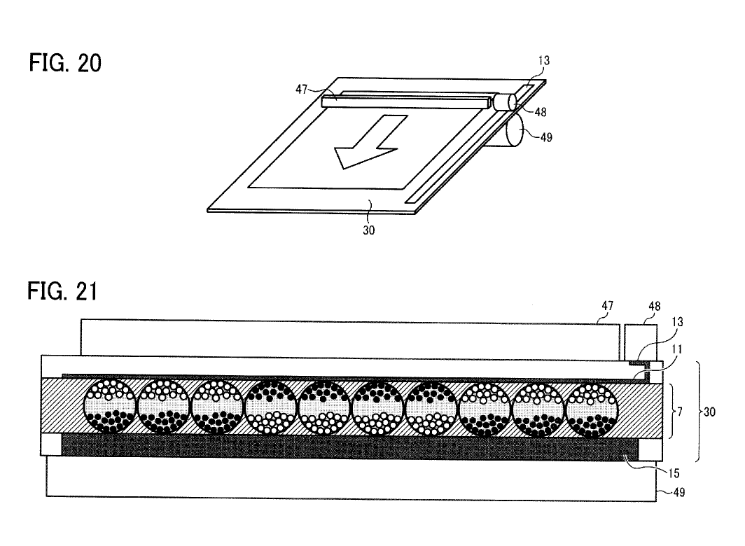

Another example of an image recording method of electrophoresis using the recording medium of the present disclosure will be exampled through FIGS. 20 and 21. However, the present disclosure is not limited to these examples.

The image recording device depicted in FIG. 20 contains a thermal head 47 serving as an image forming device to heat a certain area of the recording medium 30 of the present disclosure, an application device 48 to electrically connect with a first electrode 13 formed in an external part of the recording medium and to apply an electric field to the image recording layer in the recording medium, and an electric field application device 49 to externally connect to a second electrode 14 or an electric conductive substrate 15 (not illustrated) formed on a back surface of the recording medium, and to apply an electric field to the image recording layer in the recording medium.

FIG. 21 illustrates the state where FIG. 20 is viewed from the side, and as for the recording medium, the recording medium illustrated as one example thereof in FIG. 13 is used.

Once the recording medium 30 is set in the image recording device and is transported therein, the first electrode 13 formed in the external part of the recording medium 30 and the roller-like form application device 48 equipped with the image recording device are brought into contact with each other.

Similarly, the electrode conductive substrate 15 formed on the back surface of the recording medium 30 and the electric field application device 49 having a roller-like form provided to the image recording device are brought into contact each other.

When an electric field is applied to the application devices 48 and 49, the electric field is applied to the entire image recording layer 7.

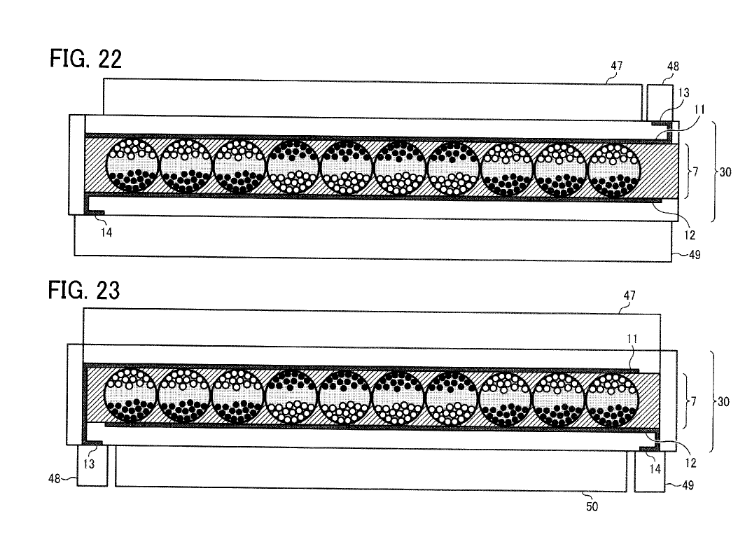

Note that, the first electric conductive layer 11 and the electric conductive substrate 15 are not electrically connected to each other, and they are insulated with the image recording layer 7. Moreover, as for other structural examples of FIG. 21, there are structures illustrated in FIGS. 22 and 23.

At the same time as the electric field is applied to the entire image recording layer 7, the predetermined area of the image recording layer 7 is heated by the thermal head 47. The area heated by the thermal head 47 is liquidized by the thermoreversible gelling agent contained in the dispersion medium in the recording medium, and the electrophoretic particles therein are allowed to move by further applying an electric field to the entire area of the image recording layer 7.

When the recorded image in the entire area of the recording medium 30 is erased, the entire area of the image recording layer 7 is heated by the thermal heat 47, while applying an electric field to the entire area of the image recording layer 7, thereby liquidizing the dispersion medium. As a result, the electrophoretic particles contributing to image formation are moved to the opposite side to the side of the image recording layer from which the image recording layer is viewed, thereby erasing the entire area of the recording medium.

In a case where positively charged black electrophoretic particles are added to the dispersion medium, for example, the black electrophoretic particles are moved to the opposite side to the side to be viewed by positively charging the side of the image recording layer 7 from which it is viewed by means of the electric field application devices 48 and 49. In a case where negatively charged white electrophoretic particles are added as well as the black electrophoretic particles, the white electrophoretic particles are moved to the side to be viewed. As a result, the entire surface turned into white so that a state where an image is erased can be created.

When an image pattern is recorded on the recording medium 30, the predetermined area of the image recording layer 7 is heated by the thermal head 47 to liquidize only the dispersion medium present in the heated area, while an electric field is applied to the entire image recording layer 7, so that the electrophoretic particles contributing to image formation are moved to the side of the image recording layer 7 from which the image recording layer 7 is viewed.

In a case where negatively charged white electrophoretic particles are contained as well as the black electrophoretic particles, the white electrophoretic particles are moved to the opposite side to the side from which it is viewed. As a result, arbitrary image patterns can be recorded.

In the case where positively charged electrophoretic particles are contained in the dispersion medium, for example, from the initial state that the entire area of the image recording layer 7 is in white, the black electrophoretic particles are moved to the side from which the image recording layer 7 by negatively charging the side of the image recording layer 7 from which it is viewed by means of the electric field application devices 48 and 49. In a case where negatively charged white electrophoretic particles are contained as well as the black electrophoretic particles, the white electrophoretic particles are moved to the opposite side to the side from which it is viewed.

As a result, the predetermined black image pattern with the white background can be recorded.

When the recording medium, to which recording or erasing has been performed in the aforementioned manner, is cooled, the dispersion medium in the recording medium 30 is turned into a state of a gel by a function of the thermoreversible gelling agent so that the electrophoretic particles contained the dispersion medium cannot move. Therefore, an image on the recording medium is stably maintained, even when the recording medium is maintained over a long period, or a stimuli is externally applied thereto.

The aforementioned image recording device using the thermal head 47 has a very simple structure, and therefore it is very effective in downsizing, reducing the weight thereof, cost waving, and powder saving. Moreover, the recording medium having an electrode at the exterior thereof or electric conductive substrate, which is used for the aforementioned image recording device, is as thin as paper, and an electric field is directly applied to the image recording layer thereof, while maintaining flexibility. Therefore, it is possible to record a high contrast image thereon with low driving voltage, and this recording medium is particularly useful in the present disclosure. The image recording set is very useful as a portable rewritable printer.

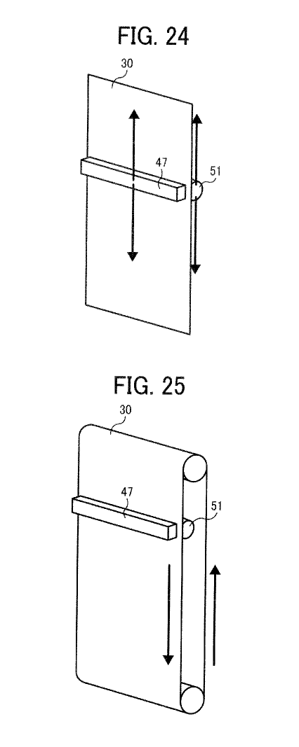

The image recording set of the present disclosure contains the aforementioned recording medium, and an image recording device equipped with a heating device to heat the recording medium, and an electric field and/or magnetic field application device to apply an electric field and/or magnetic field to the recording medium. The image recording set of the present disclosure includes, not only an embodiment where a recording medium and an image recording device, which are separately existed, are used as a set, but also an embodiment where a recording medium and an image recording device are integrated. Examples of the integrated image recording set will be illustrated in FIGS. 24 and 25.

FIG. 24 is a view illustrating the image recording set of the present disclosure, equipped with a heating device 47 to perform recording and erasing of an image on the recording medium 30 and an electric field and/or magnetic field application device 51, which are integratedly mounted with the recording medium 30 of the present disclosure.

Moreover, the image recording set contains other devices, such as an image erasing device, and a cooling device.

In the image recording set depicted in FIG. 24, the recording medium 30 is fixed, and an image can be recorded on and erased from the recording medium 30, by moving the heating device 47, and the electric field and/or magnetic field application devices 51, which had been integrated with the recording medium 30, over an external surface of the recording medium 30.

Moreover, another example, which is different from FIG. 24, is depicted in FIG. 25. FIG. 25 is a view illustrating the image recording set of the present disclosure, equipped with a heating device 47 to perform recording and erasing of an image on the recording medium 30 and an electric field and/or magnetic field application device 51, which are integratedly mounted with the recording medium 30 of the present disclosure.

Moreover, the image recording set contains other devices, such as an image erasing device, and a cooling device.

In the image recording set depicted in FIG. 25, the heating device 47 and the electric field and/or magnetic field application devices 51 and 52 are fixed, and an image can be recorded on and erased from the recording medium 30 by moving the recording medium 30 while in contact with the heating device 47 and the electric field and/or magnetic field application devices 51.

In place of the recording medium 30 in FIGS. 24 and 25, a flexible sheet screen can be used, to which the recording medium 30 is attached.

To secure electric connection between the electrode or the electroconductive substrate provided on the recording medium 30 and the electric field and/or magnetic field application devices 51, for example; electroconductive areas are formed on a part or the entire of the screen.

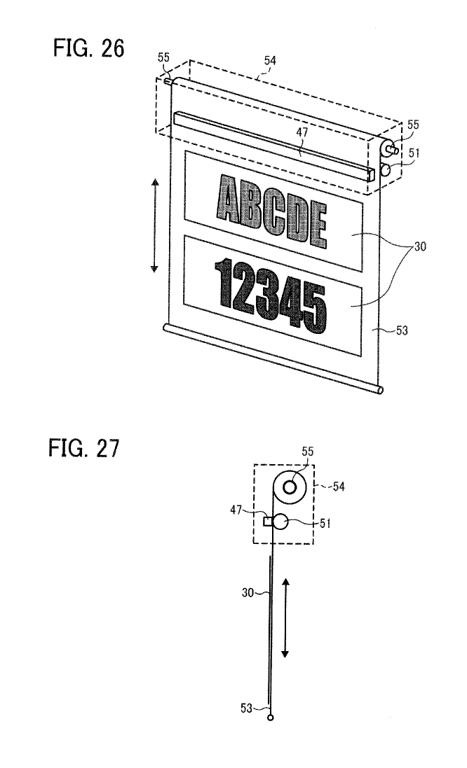

Furthermore, the image recording set of the present disclosure having a roll screen as illustrated in FIG. 26 is very suitable. The image recording set of FIG. 26 is a roll screen type having a flexible sheet-like form screen 53 and a drive unit 55 to roll up or release the screen 53 in addition to the recording medium 30, the heating device 47, and the electric field and/or magnetic field application devices 51. The recording medium 30 is provided on the screen 53. In addition, the image recording set optionally has a container 54 to accommodate the screen 53, the recording medium 30, the heating device 47, the electric field and/or magnetic field application devices 51, etc. FIG. 27 is a diagram illustrating a side view of FIG. 26. Rolling up a screen means that a screen having a sheet-like form is rolled up. Releasing a screen means drawing a screen in a reverse direction of rolling up. That is, a screen having a roll-like form is released to have a sheet-like form. In addition, the screen 53 to which the recording medium 30 is provided is formed by attaching the recording medium 30 to the screen 53. Alternatively, both are integrated.

The image recording set records or erases an image in the recording medium 30 by using the heating device and the electric field and/or magnetic field application device in the step of rolling up or releasing the screen 53 to which the recording medium 30 is provided.

Recorded and erasing images can be conducted in the step of rolling up or releasing the screen or separately.

For example, when the screen 53 to which the recording medium 30 is provided, accommodated in the container 54, is released and pulled out therefrom, it is possible to record an image in the recording medium 30 provided to the screen 53 by the heating device 47 and the electric field and/or magnetic field application devices 51. To the contrary, when the screen 53 pulled out from the container 54 is pulled thereinto, the recorded image on the recording medium 30 provided to the screen 53 can be erased by the heating device 47 and the electric field and/or magnetic field application devices 51.

In addition, it is possible to record or erase an image in the medium 30 provided to the screen 53 when the screen 53 is rolled up. Also it is possible when the screen 53 is released. Furthermore, it is possible to record an image while the screen 53 to which the recording medium 30 is provided is released, thereafter, roll up the screen 53 without erasing the image, and overwrite the image when the screen 53 is released again.

The image recording set, as illustrated in FIGS. 26 and 27, records and erases image by the heating device 47 and the electric field and/or magnetic field application devices 51.

It is also possible to provide the heating devices 47 for recording and erasing separately and the electric field and/or magnetic field application devices 51, which is suitable in terms of improvement of contrast and suppressing residual images.

In addition, in addition to a case in which only a single recording medium 30 is provided to the screen 53, multiple sheets of the recording media 30 can be provided to the screen 53 as illustrated in FIG. 26. For example, multiple color images can be demonstrated by multiple sheets of the recording media 30 having different colors while a sheet of the recording medium 30 represents only two colors.

Furthermore, the image recording device preferably has the drive unit 55 which employs an electric system in order to conduct rolling up and releasing the screen 53 at a constant speed. Additionally, it is possible and suitable to provide a screen holding member to hold the screen 53. It is preferable that the screen holding member expands and contracts to the movement of the screen 53.

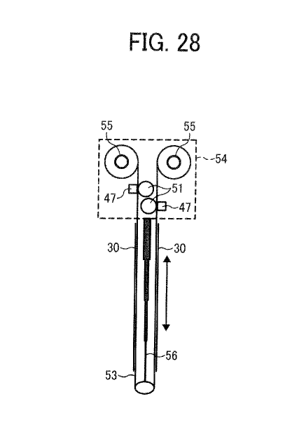

FIG. 28 is a diagram illustrating an example of an image recording set having two screens, each having the recording medium 30 to write and erase images on both sides. In this case, it is possible to record different images on the recording media 30. If the screen holding member 56 is provided to hold the screen 53, it is possible to suppress curling or twisting of the screen 53.

The advantage of the roll type image recording set of the present disclosure is, for example, as follows:

The recording medium is thin, light-weight, and flexible, so that the provided screen can be accommodated in the container, thereby improving the portability of the set.

Conventional sinages or signboards are not flexible, which requires extensive installation work for a large sinage or signboard.

Since the freedom of the installation of such a set is high, it is possible to set it on a ceiling or a window pane. For example, if it is set on a window pane, in addition to light-shielding, image can be displayed thereon;

Images in the recording medium is overwritable, which obviates the need of work such as printing, replacement, or removal of a screen. In addition, it is repeatedly usable, thereby being free from the problem of waste of the screen and ink. As a result, it is effective to reduce the cost;

Since there is no need to provide a pixel electrode or thin film transistor (TFT) substrate, the production cost is reduced, which is advantageous to size increase. Moreover, such a set is tough, so that a long working life is expected; and such a set employs a reflection type display system and retains images very good once recording is conducted, so that visibility of the images is high and the electricity to display an image is unnecessary.

The image recording set is applicable to fields of still images for signboards, advertisement, annunciators, etc.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but not limited thereto.

Measuring Method of Sol Transition Temperature and Gel Transition Temperature

The sol-gel transition temperature and gel transition temperature of the thermoreversible gelling agents for use in Examples and Comparative Examples were measured as follows.

A thermoreversible gelling agent was added in a dispersion medium and thereafter heated for melting. The resultant was sufficiently stirred followed by cooling to obtain a gel sample. The sol transition temperature and the gel transition temperature of the sample were measured by a differential scanning calorimeter (DSCQ200, manufactured by TA Instruments).

The measuring conditions were: heating the sample from 10° C. to 90° C. at a temperature rising speed of 2° C./minute, cooling it down from 90° C. to 10° C. at a temperature falling speed of 2° C./minute, and thereafter, heating the sample again from 10° C. to 90° C. The endothermic peak temperature in the second temperature rising of the DSC measuring was determined as the sol transition temperature and the exothermic peak temperature in the temperature falling was determined as the gel transition temperature.

Preparation of Electrophoretic Particle 1

A solvent mixture of 93 parts of ethanol and 7 parts of water was placed in a reaction container equipped with a stirrer and the temperature controlling device and glacial acetic acid was added there to adjust the pH thereof to be 4.5. 16 parts of 3-(trimethoxy silyl)propyl methacrylate was added and dissolved in the solvent. Thereafter, 100 parts of titanium oxide was added and stirred for 10 minutes. Next, 180 parts of ethanol was added thereto followed by stirring. After centrifugal to retrieve a solid portion, the solid portion was left all night and all day. The resultant was dried in vacuum at 70° C. for 4 hours to obtain a surface-treated titanium oxide.

Thereafter, 70 parts of toluene and 40 parts of the thus-obtained surface-treated titanium oxide were placed and stirred in a reaction container equipped with a stirrer, a thermometer, and a reflux cooler. A solution in which 50 parts of lauryl methacrylate and 0.3 parts of azobis isobutylonitrile were dissolved in 25 parts of toluene was put and stirred in the reaction container followed by heating and stirring at 70° C. and 7 hours in nitrogen atmosphere. When the reaction was complete, a solid portion was separated and refined by repeating centrifugal and toluene washing. The resultant was dried in vacuum at 70° C. for 4 hours to obtain target negatively-charged white electrophoretic particles 1.

Preparation of Electrophoretic Particle 2

14 parts of methacyloxy propyl-modified silicone (Silaplane FM-0711, manufactured by JNC Corporation), 1 part of dimethyl amino ethylmethacylate (manufactured by Tokyo Chemical Industry Co., Ltd.), and 0.1 parts of azobis dimethyl valeronitrile serving as polymerization initiator were dissolved in 180 parts of toluene and heated at 60° C. for 6 hours in nitrogen atmosphere. After the reaction was complete, toluene was removed by evaporation to obtain a dispersing agent.

Next, in a reaction vessel equipped with a stirrer, a thermometer, and a reflux condenser, 1 part of the dispersing agent, 1.5 parts of carbon black, and 200 parts of silicone oil were mixed, and irradiated with ultrasonic waves for 1 hour by a homogenizer while being cooled with ice, to thereby disperse the carbon black, 6 parts of metylmethacrylate, 3 parts of methacryloxy propyl-modified silicone (Silaplane FM-0725, molecular weight: about 10,000, manufactured by JNC Corporation), 0.1 parts of N—N,dimethyl aminopropyl acrylamide, and 0.05 parts of azobis dimethyl valeronitrile serving as polymerization initiator were added to conduct reaction at 60° C. for 6 hours. After the reaction was complete, just a solid portion was retrieved and dried to obtain target positively-chargeable black electrophoretic particles 2.

Preparation of Electrophoretic Particle 3

Electrophoretic particles 3, which were magenta color and positively chargeable, were obtained in the same manner so in preparation of the electrophoretic particles 2 except that quinacridone (PR-122, manufactured by Dainichiseika Color & Chemicals Mfg. Co., Ltd.) was used instead of carbon black.

Preparation of Electrophoretic Particle 4

Electrophoretic particles 4, which were cyan color and positively chargeable, were obtained in the same manner so in preparation of the electrophoretic particles 2 except that quinacridone (Cyanine Blue 4933M, manufactured by Dainichiseika Color & Chemicals Mfg. Co., Ltd.) was used instead of carbon black.

Synthesis of Thermoreversible Gelling Agent

An example of the synthesized thermoreversible gelling agent is shown below.

The following thermoreversible gelling agent represented by Chem 12 was synthesized referring to the method disclosed in JP-2004-182697-A. The following thermoreversible gelling agents represented by Chem 13 to Chem 26 were synthesized referring to the method disclosed in JP-2005-232108-A.

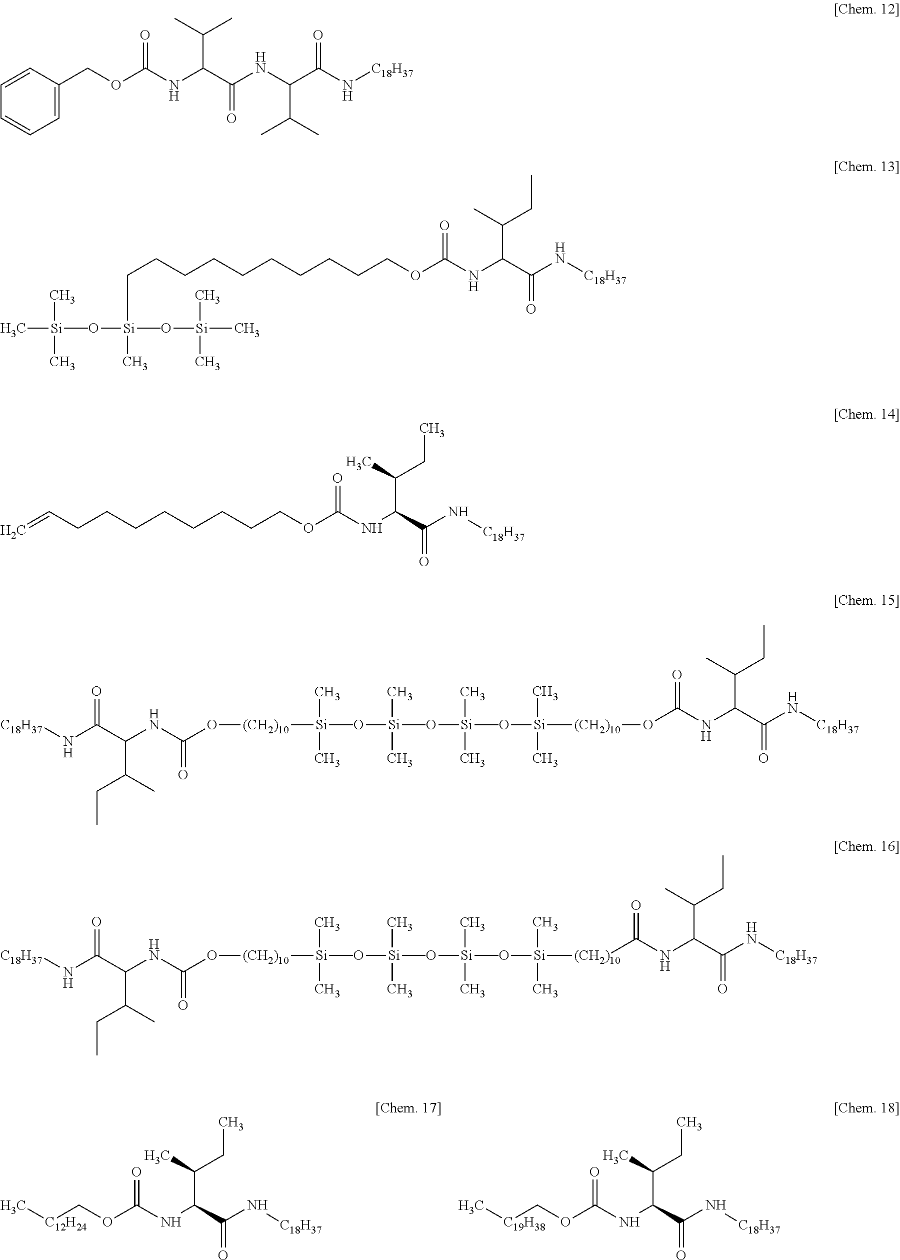

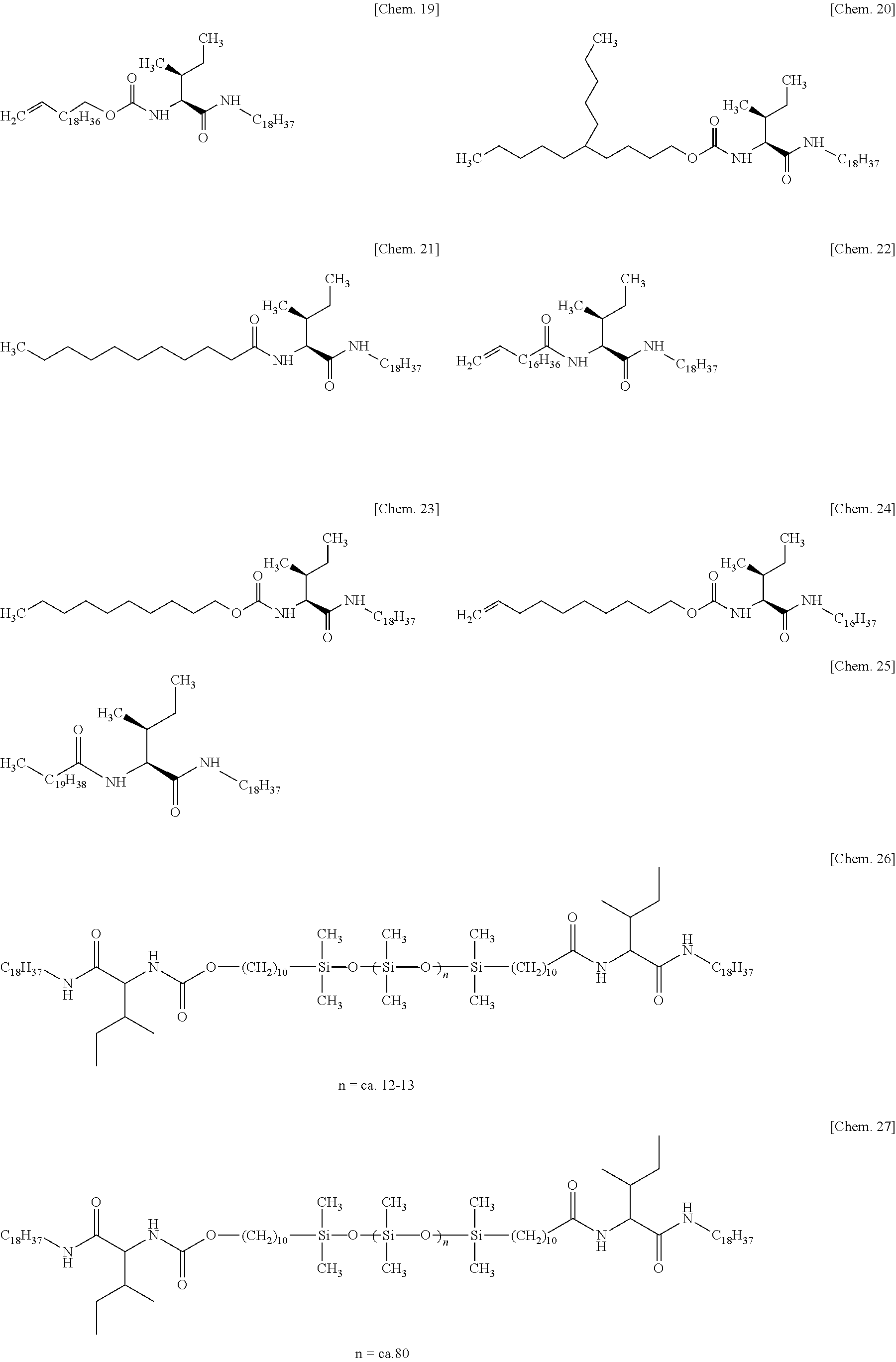

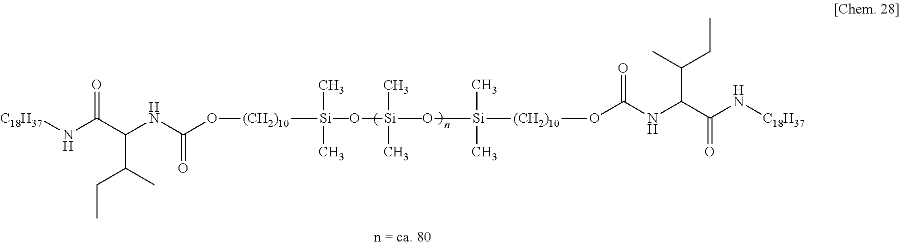

### Example 1

### Preparation of Liquid Dispersion 1

4.0 parts of the white electrophoretic particles 1, 0.2 parts of the cyan electrophoretic particles 4, 0.05 parts of a dispersing agent (Solsperse 17000, manufactured by the Lubrizol Corporation), and 0.05 parts of a surfactant (Span 20, sorbitan monolaurate, manufactured by Tokyo Chemical Industry Co. Ltd.) were added to 5.7 parts of isoparaffin-based hydrocarbon solvent (ISOPAR™ G, manufactured by Exxon Mobil Corporation) followed by ultrasonic dispersion. After the resultant was heated to the sol transition temperature or higher, 0.5 parts of the thermoreversible gelling agent of Chem 15 was added thereto followed by heating and mixing at the sol transition temperature or higher to prepare liquid dispersion 1.

The endothermic peak temperature (sol transition temperature) in the temperature rising and the exothermic peak temperature (gel transition temperature) in the temperature falling of the gel sample of the theremoreversible gelling agents of Chem 15 and the isoparaffin-based hydrocarbon solvent were 51° C. and 41° C., respectively, as measured by the DSC measurement.

### Preparation of Microcapsule Slurry 1

Gelatin was added to water, which was thereafter heated to 40° C. and stirred for 30 minutes to obtain 100 parts of 2.5% gelatin aqueous solution. Thereafter, the solution was heated to the sol transition temperature or higher. While the gelatin was being stirred, 15 parts of the liquid dispersion 1, which was preliminarily heated to the sol transition temperature or higher, was added slowly below the liquid surface of the gelatin aqueous solution. Next, 25 parts of 5% gum arabic aqueous solution was placed therein followed by stirring for 30 minutes. Thereafter, 10% acetic acid aqueous solution was added dropwise to the aqueous solution until the pH of the system was 3.5 followed by stirring for 30 minutes.

Thereafter, the liquid temperature was maintained at 5° C. for 60 minutes and 1.2 parts of 25% glutal aldehyde aqueous solution was slowly added dropwise to the resultant followed by stirring for 30 minutes. Thereafter, 10% sodium hydroxide was added dropwise to the resultant until the pH of the system was 9.0 followed by stirring for 30 minutes. Thereafter, the temperature of the resultant was raised to 40° C., and the resultant was stirred for 120 minutes, followed by cooling to room temperature and stirred for a day and night.

The finally-obtained capsule slurry was repeatedly washed with water until the pH of the washing water was 5.0 followed by classification using a screen to obtain microcapsule slurry 1.

### Preparation of Liquid Dispersion 2

A liquid dispersion 2 was prepared in the same manner as in the preparation of the liquid dispersion 1 except that the electrophoretic particles having cyan color was changed to the electrophoretic particles 3 having magenta color, no dispersion agent was added, and the isoparaffin-based hydrocarbon solvent serving as dispersion medium was changed to silicone oil (KF96-10sc, manufactured by Shin-Etsu Silicone Co. Ltd.).

The endothermic peak temperature (sol transition temperature) in the temperature rising and the exothermic peak temperature (gel transition temperature) in the temperature falling of the gel sample of the theremoreversible gelling agents of Chem 15 and silicone oil were 79° C. and 69° C., respectively, as measured by the DSC measurement.

### Preparation of Microcapsule Slurry 2

Microcapsule slurry 2 was prepared in the same manner as in preparation of the microcapsule slurry 1 by using the liquid dispersion 2.

### Manufacturing of Recording Medium 1

After mixing the microcapsule slurry 1 and the microcapsule slurry 2 at a weight ratio of 1:1, the mixture was mixed with a urethane resins for heat-seal to form an image recording layer on a polyester substrate having a thickness of 50 μm by blade application.

The image recording layer was naturally dried and further dried at 70° C. for 30 minutes. Thereafter, a thermocurable liquid resin having insulating properties was thinly applied onto the image recording layer by a blade just to cover the image recording layer followed by curing at 80° C. for 30 minutes to manufacture a recording medium 1.

### Example 2

### Preparation of Liquid Dispersion 3

A liquid dispersion 3 was prepared in the same manner as in Example 1 except that the thermoreversible gelling agent of Chem 15 contained in the liquid dispersion 1 was changed to the thermoreversible gelling agent of Chem 13 and the electrophoretic particles 4 having cyan color was changed to the electrophoretic particles 2 having black color. The endothermic peak temperature (sol transition temperature) in the temperature rising and the exothermic peak temperature (gel transition temperature) in the temperature falling of the gel sample of the theremoreversible gelling agents of Chem 13 and the isoparaffin-based hydrocarbon solvent were 45 CC and 30° C., respectively, as measured by the DSC measurement.

### Preparation of Liquid Dispersion 4

A liquid dispersion 4 was prepared in the same manner as in Example 1 except that the thermoreversible gelling agent of Chem 15 contained in the liquid dispersion 1 was changed to the thermoreversible gelling agent of Chem 16. The endothermic peak temperature (sol transition temperature) in the temperature rising and the exothermic peak temperature (gel transition temperature) in the temperature falling of the gel sample of the theremoreversible gelling agents of Chem 16 and the isoparaffin-based hydrocarbon solvent were 59° C. and 24° C., respectively, as measured by the DSC measurement.

### Preparation of Microcapsule Slurries 3 and 4

Microcapsule slurries 3 and 4 were prepared in the same manner as in Example 1 by using the liquid dispersions 3 and 4.

### Manufacturing of Recording Medium 2

Recording medium 2 was manufactured in the same manner as in Example 1 after mixing the microcapsule slurry 3 and the microcapsule slurry 4 at a weight ratio of 1:1.

### Example 3

### Preparation of Liquid Dispersion 5 and Microcapsule Slurry 5

A liquid dispersion 5 and a microcapsule slurry 5 were prepared in the same manner as in Example 1 except that 4.0 parts of the white electrophoretic particles 1 contained in the liquid dispersion 1 is changed to 2.2 parts, no cyan color electrostatic particles 4 were added, 0.05 parts of blue color dye (Oil Blue 2N, manufactured by Orient Chemical Corporation) serving as colorant was added, and the amount of the dispersion medium was increased to 7.7 parts.

### Manufacturing of Recording Medium 3

Recording medium 3 was manufactured in the same manner as in Example 1 after mixing the microcapsule slurry 5 and the microcapsule slurry 2 at a weight ratio of 1:1.

### Comparative Example 1

### Manufacturing of Recording Medium 4

A liquid dispersion 4 was prepared in the same manner as in Example 1 except that no thermoreversible gelling agent contained in the liquid dispersion 1 or the liquid dispersion 2 was added.

### Comparative Example 2

### Manufacturing of Recording Medium 5

A liquid dispersion 5 was prepared in the same manner as in Example 1 except that the silicone oil contained in the liquid dispersion 2 was changed to the isoparaffin-based hydrocarbon solvent of the liquid dispersion 1.

Image Evaluation

The recording media 1 to 5 of Examples 1 to 3 and Comparative Example 2 were reversed by the following method to evaluate the thus-obtained images. First, the recording medium 1 is described.

The image forming device used had a configuration in which a corona charger serving as charger conducted charging while moving over an image recording medium set on a grounded metal plate in a non-contact manner. As the heating device, a hot plate was provided to the reverse side of the metal plate to heat each metal plate.

After the recording medium was set on the metal plate and heated to 90° C. by using the hot plate followed by positively charging the entire of the recording medium by the corona charger, the entire surface was turned white. Next, after cooling the recording medium to 20° C. by air and water, the recording medium was heated again to 90° C. using the hot plate followed by negatively charging the entire thereof by a corona charger to change the color from white to a mixed color (blue) of cyan and magenta. Next, after cooling the recording medium to 20° C. by air and water, the recording medium was heated again to 60° C. using the hot plate followed by positively charging the entire thereof by a corona charger to change the color from blue to a mixed color (light red violet) of white and magenta. Finally, after heating the entire surface of the recording medium to 90° C. followed by negative charging of the entire surface by the corona charger to temporarily reverse the entire surface to white. Subsequent to being cooled down to 20° C., the entire surface of the recording medium was heated to 60° C. by using the hot plate again and thereafter subject to negative charging by a corona charger, thereby changing the color to a mixed color (sky blue) of white and cyan. Therefore, the recording medium demonstrated four color display of white, blue, light red violet, and sky blue. Again, after the entire surface was heated again to 90° C. by a hot plate followed by positively charging the entire surface of the recording medium by the corona charger, the entire surface was turned to white, meaning that the image was erased.

The recording media 2 to 5 were evaluated in the same manner for the recording medium 1.

Table 1 shows the color (white) when the entire surface was initially reversed to white by positive charging at 90° C., the changes of colors followed by cooling and negative charging at 90° C., the changes of colors subsequent to cooling and positive charging at 60° C., and finally the changes of colors when the entire colors were reversed to white followed by negative charging at 60° C. As for the evaluation of the recording medium 2, the heating temperature was 50° C. instead of 60° C.

TABLE 1

| Example | | | | Sol | 90° C. | 90° C. | 60° C. | 60° C. |
|---|---|---|---|---|---|---|---|---|
| Comparative | | Gelling | Dispersion | transition | positive | negative | positive | negative |
| Example | Color | agent | medium | temp. | charging | charging | charging | charging |
| Example 1 | W/C | Chem 15 | ISOPAR ™ | 51° C. | White | Blue | Light red | Aqua |
| | W/M | Chem 15 | Silicone | 79° C. | | | violet | |
| | | | oil | | | | | |
| Example 2 | W/K | Chem 13 | ISOPAR ™ | 45° C. | White | Dark | Aqua | Gray |
| | W/C | Chem 16 | ISOPAR ™ | 59° C. | | blue | | |
| Example 3 | W/B | Chem 15 | ISOPAR ™ | 51° C. | White | Blue | Light red | Blue |
| | W/M | Chem 15 | Silicone | 79° C. | | violet | violet | |
| | | | oil | | | | | |
| Comparative | W/C | None | ISOPAR ™ | — | White | Blue | White | Blue |
| Example 1 | W/M | None | Silicone | — | | | | |
| | | | oil | | | | | |
| Comparative | W/C | Chem 15 | ISOPAR ™ | 51° C. | White | Blue | White | Blue |
| Example 2 | W/M | Chem 15 | ISOPAR ™ | 51° C. | | | | |

In Table 1, “W” means white, “K” means black, “C” means cyan, “M” means magenta, and “B” mean blue.

In addition, ISOPAR™ represents isoparaffin-based hydrocarbon solvent (ISOPAR™ G, manufactured Exon Chemical Co., Ltd.) and silicone oil represents KF96-10sc, manufactured by Shin-Etsu Silicone Co. Ltd.

As described above, the recording media 1 to 3 of the present disclosure were capable of displaying four colors and no change in the color was observed after the recording medium was left as was for two months. In addition, no image was disturbed by finger touch after printing. On the other hand, the recording media 4 and 5 were capable of displaying only two colors. Furthermore, images on the recording medium 4 containing no thermoreversible gelling agent were disturbed by finger touch after printing. Moreover, when taking the recording medium out of the metal plate, the color changed by electrostaticity, meaning that the image retentiveness is extremely poor.

### Example 4

### Manufacturing of Recording Medium 6

After mixing the microcapsule slurry 1 and the microcapsule slurry 2 obtained in Example 1 at a weight ratio of 1:1, the mixture was mixed with a urethane resins for heat-seal to form an image recording layer on the ITO film of a polyester substrate having a thickness of 50 μm by blade application with the ITO (indium oxide •tin) film on one side. The image recording layer was naturally dried and further dried at 70° C. for 30 minutes. Thereafter, a thermocurable liquid resin having insulating properties was thinly applied by a blade just to cover the microcapsule layer followed by drying at 80° C. for 30 minutes for curing.

Furthermore, a metal foil tape was attached to the end at which the ITO surface was bare with neither image recording layer nor the thermocurable resin applied. Thereafter, it was folded to form a portion electrically connected to the surface of the polyester substrate, which served as electrode. Thereafter, the end was insulated to manufacture a recording medium 6.

### Example 5

### Manufacturing of Recording Medium 7

In Example 4, a thermocurable liquid resin having insulation property was applied to the microcapsule layer. Subsequent to drying and curing, silver paste (DOTITE, manufactured by Fujikura Kasei Co., Ltd.) was applied thereto by a blade followed by drying.

Furthermore, a metal foil tape was attached to the end at which the ITO surface was bare with neither image recording layer nor the thermocurable resin applied. Thereafter, it was folded to form a portion electrically connected to the surface of the polyester substrate, which served as electrode. Thereafter, the end was insulated to manufacture a recording medium 7.

### Example 6

### Manufacturing of Recording Medium 8

In Example 4, a thermocurable liquid resin having insulation property was applied to the microcapsule layer. Prior to drying, the ITO surface of the polyester substrate to which an ITO film was provided was attached to the layer followed by smoothing by a roller and curing. Furthermore, metal foil tapes were attached to the non-attached surface and ITO surface at the back surface. Thereafter, it was folded in such a manner that these tapes were not in contact to form a portion electrically connected to the surface and the back surface of the polyester substrate, which served as electrode. Thereafter, the end was insulated to manufacture a recording medium 8.

### Example 7

### Preparation of Liquid Dispersion 6

2.0 parts of the white electrophoretic particles 1, 0.05 parts of a surfactant (Span 20, sorbitan monolaurate, manufactured by Tokyo Chemical Industry Co., Ltd.), and 0.05 parts of yellow colorant (OilYellow GG-S, manufactured by Orient Chemical Industries Co., Ltd.) were added to 7.9 parts of silicone oil (KF-96, 10cs, manufactured by Shin-Etsu Corporation) followed by ultrasonic treatment to prepare a liquid dispersion. After the resultant was heated to the sol transition temperature or higher, 0.5 parts of the thermoreversible gelling agent of Chem 28 was added thereto followed by stirring to prepare liquid dispersion 6. The endothermic peak temperature (sol transition temperature) in the temperature rising and the exothermic peak temperature (gel transition temperature) in the temperature falling of the gel sample of the mixture of theremoreversible gelling agents and the dispersion medium were 66° C. and 41° C., respectively, as measured by the DSC measurement as described above.

### Preparation of Microcapsule Slurry 6

Microcapsule slurry 6 was prepared in the same manner as in Example 1 by using the liquid dispersion 6.

### Manufacturing of Recording Medium 9

The microcapsule slurry 2 obtained in Example 1 and the microcapsules slurry 6 were mixed at a weight ratio of 1:1 and further mixed with a urethane resin for heat-seal.

Thereafter, the recording medium 9 was manufactured in the same manner as in Example 5.

### Example 8

### Manufacturing of Recording Medium 10

Recording medium 10 was manufactured in the same manner as in Example 5 by using the microcapsule slurry 5 and the microcapsule slurry 6.

### Comparative Example 3

### Manufacturing of Recording Medium 11

A liquid dispersion 11 was prepared in the same manner as in Example 5 except that no thermoreversible gelling agent was added.

### Comparative Example 4

### Manufacturing of Recording Medium 12

A liquid dispersion 12 was prepared in the same manner as in Example 5 except that dispersion medium contained in the microcapsule slurry 1 was changed to silicone oil (KF-96, 10cs, manufactured by Shin-Etsu Silicone Co. Ltd.).

Method of Evaluating Image

The recording media 6 to 12 of Examples 4 to 8 and Comparative Examples 3 and 4 were reversed by the following method to evaluate the thus-obtained images.

An image recording device illustrated in FIGS. 20 and 21 were manufactured and images were printed on recording media by using the device for evaluation. The image recording devices were designed such that the recording medium was transferred in a straight line. On the side of the recording medium to be viewed were arranged the heating device using a thermal head and the electric field application device having a roller-like form to generate an electric field in the image recording layer while electrically connected to the electrode of the recording medium. The thermal head was able to be set at any arbitrary temperature. On the reverse side of the recording medium, i.e., the side of the recording medium not to be viewed, an electroconductive platen roller was provided that was able to apply an electric field.

Furthermore, a fan was provided as a cooler to the portion from which the recording medium as discharged.

For example, it is possible to generate an electric field of +50 V in the image recording layer of a recording medium when 50 V is applied to an electric field application device arranged on the side of the recording medium to be viewed and an electric field application device (electroconductive platen roller) arranged on the reverse side is grounded.

On the other hand, it is possible to generate an electric field of −50 V in the image recording layer of a recording medium when an electric field application device arranged on the side of the recording medium to be viewed is grounded and 50 V is applied to an electric field application device arranged on the reverse side.

Image Evaluation

The recording medium 6 was set in the image recording device described above and a solid pattern was input on the entire of the recording medium while +50 V was applied to the image recording layer by an electric field application device and the temperature of the thermal head was set to 90° C. As a result, the entire surface of the recording medium 6 was turned to white. Thereafter, the recording medium 6 was again set in the image recording device and a checker pattern was output on the right half of the recording medium while −50 V was applied to the image recording layer and the temperature of the thermal head was set to 90° C.

As a result, the left half remained unchanged as white and a checker pattern of white and blue was printed on the right half. Thereafter, a black belt pattern on the right half was output while +50 V was applied to the image recording layer and the temperature of the thermal head was set to 60° C. As a result, the left half remained unchanged as white and the checker pattern on the right half was changed from blue to light red violet. Finally, texts were output on the left half of the recording medium while −50 V was applied to the image recording layer and the temperature of the thermal head was set to 60° C. As a result, it was confirmed that the right half of the recording medium remained unchanged but aqua texts were printed on the left half.

Images were printed on the recording media 7 to 12 like the recording medium 6 and the changes in color were observed. The results are shown in Table 2. As for the recording medium 9, the temperature set for the thermal head was changed from 60° C. to 73° C. for evaluation.

In addition, the obtained images were visually confirmed for evaluation. The evaluation criteria are as follows. The results are shown in Table 2.

Evaluation Criteria

A: No particular problem observed with good image quality.

B: The quality of images were slightly inferior but with no practical problem

C: The level above which the present disclosure is effective

TABLE 2

| Example | | | | Sol | 90° C. | 90° C. | 60° C. | 60° C. | |
|---|---|---|---|---|---|---|---|---|---|
| Comparative | | Gelling | Dispersion | transition | positive | negative | positive | negative | Image |
| Example | Color | agent | medium | temp. | charging | charging | charging | charging | Evaluation |
| Example 4 | W/C | Chem 15 | ISOPAR ™ | 51° C. | White | Blue | Light red | Aqua | Contrast: B |
| | W/M | Chem 15 | Silicone oil | 79° C. | | | violet | | Retentive- |
| | | | | | | | | | ness: A |
| Example 5 | W/C | Chem 15 | ISOPAR ™ | 51° C. | White | Blue | Light red | Aqua | Contrast: A |
| | W/M | Chem 15 | Silicone oil | 79° C. | | | violet | | Retentive- |
| | | | | | | | | | ness: A |
| Example 6 | W/C | Chem 15 | ISOPAR ™ | 51° C. | White | Blue | Light red | Aqua | Contrast A |
| | W/M | Chem 15 | Silicone of | 79° C. | | | violet | | Retentive- |
| | | | | | | | | | ness: A |
| Example 7 | W/Y | Chem 28 | Silicone oil | 66° C. | White | Red | Light red | Yellow | Contrast: A |
| | W/M | Chem 15 | Silicone oil | 79° C. | | | violet | | Retentive- |
| | | | | | | | | | ness: A |
| Example 8 | W/Y | Chem 28 | Silicone oil | 66° C. | White | Green | Light | Blue | Contrast A |
| | W/B | Chem 15 | ISOPAR ™ | 51° C. | | | yellow | | Retentive- |
| | | | | | | | | | ness: A |
| Comparative | W/C | None | ISOPAR ™ | — | White | Blue | White | Blue | Two color: |
| Example 3 | W/M | None | Silicone oil | — | | | | | C |
| | | | | | | | | | Retentive- |
| | | | | | | | | | ness: C |
| Comparative | W/C | Chem 15 | Silicone oil | 79° C. | White | Blue | Blue | White | Two color: |
| Example 4 | W/M | Chem 15 | Silicone oil | 79° C. | | | | | C |
| | | | | | | | | | Retentive- |
| | | | | | | | | | ness: A |

In Table 2, “W” means white, “C” means cyan, “M” means magenta, “Y” means yellow, and “B” means blue.

In addition, ISOPAR™ represents isoparaffin-based hydrocarbon solvent (ISOPAR™ G, manufactured Exon Chemical Co., Ltd.) and silicone oil represents KF96-10sc, manufactured by Shin-Etsu Silicone Co. Ltd.

The recording medium of the present disclosure is capable of printing image patterns with various colors by using a thermal head for a heating device. In addition, better images were obtained by providing electrodes to both sides of a recording medium than one side thereof since the contrast and the color reproducibility were improved. Furthermore, no change in the color was observed after the recording medium was left as was for two months, which confirmed that the recording medium had excellent image retentiveness. On the other hand, when no thermoreversible gelling agent was added, only two colors were printed, the change in color occurred immediately after printing, the image was damaged at finger touch or when the recording medium was taken out from the image recording device, so that the image was not retained. In addition, when the sol transition temperature and the gel transfer temperature of the microcapsule having different color particles were set to be the same, the image was displayed in only two colors, which failed to satisfy the level of the present disclosure.

### Example 9

### Manufacturing of Recording Medium 13

Recording medium 13 was manufactured in the same manner as in Example 6 after mixing the microcapsule slurry 1, the microcapsule slurry 2, and the microcapsule slurry 6 at a weight ratio of 1:1:1.

The recording medium 13 was set in the image recording device described above and a solid pattern was input on the entire of the recording medium while +70 V was applied to the image recording layer by an electric field application device and the temperature of the thermal head was set to 90° C. As a result, the entire surface of the recording medium 13 was changed to white. Thereafter, the recording medium 13 was again set in the image recording device and a checker pattern was output on the entire surface of the recording medium while −70 V was applied to the image recording layer and the temperature of the thermal head was set to 90° C. As a result, a checker pattern of dark gray on the background of white was output. Thereafter, a solid pattern was output while +70 V was applied to the image recording layer and the temperature of the thermal head was set to 72° C. As a result, the dark gray portion in the checker pattern was changed to a light red violet and a checker pattern of light red violet on the background of white was output. Thereafter, a solid pattern was output while −70 V was applied to the image recording layer and the temperature of the thermal head was set to 72° C. As a result, the background portion of white was changed to green and the light red violet portion of the checker pattern was changed to dark gray, so that a checker pattern of green and dark gray was output. Next, a solid pattern was output while +70 V was applied to the image recording layer and the temperature of the thermal head was set to 60° C. As a result, the background portion of green was changed to yellow and the dark gray portion in the checker pattern was changed to red, so that a checker pattern of yellow and red was output. Thereafter, a solid pattern was output while +70 V was applied to the image recording layer and the temperature of the thermal head was set to 72° C. As a result, the background portion of yellow was changed to white and the red portion in the checker pattern was changed to light red violet, so that a checker pattern of white and light red violet was output. Finally, a solid pattern was output while −70 V was applied to the image recording layer and the temperature of the thermal head was set to 60° C. Consequently, the background portion of white was changed to sky blue and the light red violet portion in the checker pattern was changed to blue, so that a checker pattern of sky blue and blue was output.

### Example 10

### Preparation of Liquid Dispersion 7

2.0 parts of the magenta electrophoretic particles 3, 2.0 parts of white polyvinyl naphthalene particles as non-electrophoretic particles, 0.05 parts of a surfactant (Span 20, sorbitan monolaurate, manufactured by Tokyo Chemical Industry Co., Ltd.), and 0.05 parts of colorant (OilYellow GG-S, manufactured by Orient Chemical Industries Co., Ltd.) were added to 5.9 parts of silicone oil (KF-96, 10cs, manufactured by Shin-Etsu Corporation) followed by ultrasonic treatment to prepare a liquid dispersion. After the resultant was heated to the sol transition temperature or higher, 0.5 parts of the thermoreversible gelling agent of Chem 15 was added thereto followed by stirring to prepare liquid dispersion 7.

### Preparation of Liquid Dispersion 8

A liquid dispersion 8 was prepared in the same manner as in preparation of the liquid dispersion 7 except that the silicone oil contained in the liquid dispersion 7 was changed to the isoparaffin-based hydrocarbon solvent (ISOPAR™ G, manufactured by Exon Chemical Co., Ltd.), the electrophoretic particles 3 was changed to the electrophoretic particles 4, and no colorant was added.

### Preparation of Microcapsule Slurry 7 and 8

Microcapsule slurries 7 and 8 were prepared in the same manner as in Example 1 by using the liquid dispersions 7 and 8.

### Manufacturing of Recording Medium 14

Recording medium 14 was manufactured in the same manner as in Example 5 by using a mixture of the microcapsule slurry 7 and the microcapsule slurry 8 at a weight ratio of 1.2:0.8.

The recording medium 14 was set in the image recording device described above and a solid pattern was input on the entire of the recording medium while +60 V was applied to the image recording layer by an electric field application device and the temperature of the thermal head was set to 90° C. As a result, the entire surface of the recording medium 14 was changed to pale yellow. Thereafter, the recording medium 14 was again set in the image recording device and a checker pattern was output on the entire surface of the recording medium while −60 V was applied to the image recording layer and the temperature of the thermal head was set to 90° C. As a result, a checker pattern of blue on the background of pale yellow was output. Next, a solid pattern was output while +60 V was applied to the image recording layer and the temperature of the thermal head was set to 60° C. As a result, the background portion of pale yellow of the checker pattern remained unchanged and the blue portion was changed to green, so that a background portion of pale yellow and green was output. Next, a solid pattern was output while −60 V was applied to the image recording layer and the temperature of the thermal head was set to 60° C. Consequently, the background portion of pale yellow of the checker pattern was changed to light red violet and the green portion of the checker pattern was changed to blue, so that a checker pattern of light red violet and blue was output. The color became more vivid because of the polyvinyl naphthalene contained.

### Example 11

### Preparation of Liquid Dispersion 9

A liquid dispersion 9 was prepared in the same manner as in Example 1 except that the content of thermoreversible gelling agent was changed to 0.1 parts. The endothermic peak temperature (sol transition temperature) in the temperature rising and the exothermic peak temperature (gel transition temperature) in the temperature falling of the gel sample of the theremoreversible gelling agents of Chem 15 and the isoparaffin-based hydrocarbon solvent were 46° C. and 36° C., respectively, as measured by the DSC measurement.

### Preparation of Liquid Dispersion 10

A liquid dispersion 10 was prepared in the same manner as in Example 1 except that the content of thermoreversible gelling agent was changed to 0.8 parts and the electrophoretic Particles 4 was changed to the magenta electrophoretic particles 4 in the dispersion liquid 1 of Example 1. The endothermic peak temperature (sol transition temperature) in the temperature rising and the exothermic peak temperature (gel transition temperature) in the temperature falling of the gel sample of the theremoreversible gelling agents of Chem 15 and the isoparaffin-based hydrocarbon solvent were 54° C. and 45° C., respectively, as measured by the DSC measurement.

### Preparation of Microcapsule Slurries 9 and 10

Microcapsule slurries 9 and 10 were prepared in the same manner as in Example 1 by using the liquid dispersions 9 and 10.

### Manufacturing of Recording Medium 15

Recording medium 15 was manufactured in the same manner as in Example 5 by using a mixture of the microcapsule slurry 9 and the microcapsule slurry 10 at a weight ratio of 1:1.

The recording medium 15 was set in the image recording device described above and a solid pattern was input on the entire of the recording medium while +60 V was applied to the image recording layer by an electric field application device and the temperature of the thermal head was set to 70° C. As a result, the entire surface of the recording medium 15 was changed to white. Thereafter, the recording medium 15 was again set in the image recording device and a checker pattern was output on the entire surface of the recording medium while −60 V was applied to the image recording layer and the temperature of the thermal head was set to 70° C. As a result, a checker pattern of blue on the background of white was output. Next, a solid pattern was output while +60 V was applied to the image recording layer and the temperature of the thermal head was set to 50° C. As a result, the background portion of white in the checker pattern remained unchanged and the blue portion of the checker pattern was changed to light red violet, so that a checker pattern of white and light red violet was output. Next, a solid pattern was output while −60 V was applied to the image recording layer and the temperature of the thermal head was set to 50° C. Consequently, the background portion of white in the checker pattern was changed to aqua and the light red violet portion of the checker pattern was changed to blue, so that a checker pattern of aqua and blue was output.

### Example 12

### Forming of Image Recording Layer Using Cell

A curable epoxy resin was applied to a polyamide film having an ITO surface and a thickness of 20 μm. After a semi-cured state was obtained, the epoxy resin layer was subject to embossing treatment to form a cell aggregation having a honeycomb-like form in which hexagonal concave portions having a diagonal of about 150 μm at maximum were arranged in matrix.

The cell aggregation was exposed to ultraviolet ray to cure the epoxy resin to form a cell aggregation having a thickness of about 50 μm on the substrate.

### Manufacturing of Recording Medium 16

A spacer having a thickness of 50 μm with thermocurable attachment surfaces on both sides was attached around the cell aggregation like a frame. This was set on a hot plate and heated to the sol transition temperature thereof or higher of the liquid dispersion 1. The liquid dispersion 1 and the liquid dispersion 2 preliminarily heated were charged into the cells at random by an inkjet device. A polyamide film substrate having a thickness of 20 μm to which a sealant was applied was attached thereonto by a roller to prevent air bubbles from entering into the cells for heat sealing. Furthermore, a metal foil tape was attached to the ITO surface, which was thereafter folded in half to form a portion that was electrically connected to the surface of the polyester substrate, which served as an electrode. Finally, a recording medium 16 was manufactured by applying a UV curable sealant to the end portions of the two substrates and curing by UV ray irradiation for sealing.

The recording medium 16 was set in the image recording device described above and a solid pattern was input on the entire of the recording medium while +150 V was applied to the image recording layer by an electric field application device and the temperature of the thermal head was set to 90° C.

As a result, the entire surface of the recording medium 15 was changed to white.

Thereafter, the recording medium 16 was again set in the image recording device and a checker pattern was output on the entire surface of the recording medium while −150 V was applied to the image recording layer and the temperature of the thermal head was set to 90° C. As a result, a checker pattern of blue on the background of white was output. Next, a solid pattern was output while +150 V was applied to the image recording layer and the temperature of the thermal head was set to 60° C. As a result, the background portion of white in the checker pattern remained unchanged and the blue portion of the checker pattern was changed to light red violet, so that a checker pattern of white and light red violet was output. Next, a solid pattern was output while −150 V was applied to the image recording layer and the temperature of the thermal head was set to 60° C. Consequently, the background portion of white in the checker pattern was changed to aqua and the light red violet portion of the checker pattern was changed to blue, so that a checker pattern of aqua and blue was output.

### Example 13

### Preparation of Liquid Dispersion 11

0.2 parts of black ferrite particles having a surface treated with silicone oil and 0.05 parts of a surfactant (Span 20, sorbitan monolaurate, manufactured by Tokyo Chemical Industry Co., Ltd.) were added to 1.75 parts of silicone oil (KF-96, 10cs, manufactured by Shin-Etsu Corporation) followed by ultrasonic treatment to prepare a liquid dispersion 11-1. To 4.0 parts of the silicone oil was added 4.0 parts of non-migration type polyvinyl naphthalene particle as white particles followed by stirring and ultrasonic dispersion to prepare a liquid dispersion 11-2. After these liquid dispersion were mixed followed by ultrasonic wave dispersion, the resultant was heated to the sol transition temperature or higher, 0.5 parts of the thermoreversible gelling agent of Chem 26 was added thereto followed by stirring to prepare liquid dispersion 11. The endothermic peak temperature (sol transition temperature) in the temperature rising and the exothermic peak temperature (gel transition temperature) in the temperature falling of the gel sample of the theremoreversible gelling agents of Chem 26 and silicone oil were 85° C. and 49° C., respectively, as measured by the DSC measurement.

### Preparation of Liquid Dispersion 12

A liquid dispersion as prepared in the same manner as in Example 11 except that the thermoreversible gelling agent of Chem 26 was changed to the thermoreversible gelling agent of Chem 28 and 0.05 parts of colorant (OilRed 5B, manufactured by Orient Chemical Industries Co., Ltd.) was added.

### Preparation of Microcapsule Slurries 11 and 12

Microcapsule slurries 11 and 12 were prepared in the same manner as in Example 1 by using the liquid dispersions 11 and 12.

### Manufacturing of Recording Medium 17

Recording medium 17 was manufactured in the same manner as in Example 1 by using a mixture of the microcapsule slurry 11 and the microcapsule slurry 12 at a weight ratio of 1:1.

The recording medium 17 was reversed using the following image recording device to evaluate the thus-obtained images. The image recording device was designed to convey a recording medium in a straight line. Also, a thermal head serving as heating device was arranged on the side of the recording medium to be viewed and an electric magnet serving as a magnetic field application device (magnetic head) was arranged on the reverse side. For example, if a magnetic field is applied to repel black particles by the magnetic field application device and the area to record an image is heated by a heating device to a temperature higher than the sol transition temperature of a dispersion medium at the same time, the printing area is turned to black. By contrast, if a magnetic field is applied to attract black particles by the magnetic field application device and the area to record an image is heated by a heating device to a temperature higher than the sol transition temperature of a dispersion medium at the same time, the printing area is turned to white. Furthermore, a fan was provided as a cooler to the portion from which the recording medium was ejected.

The recording medium 17 was set in the image recording device described above and a black solid pattern was input on the entire of the recording medium while a magnetic field was initially applied to attract black particles and the temperature of the thermal head was set to 90° C. As a result, the entire surface of the recording medium 17 was changed to light red. Thereafter, a checker pattern was output on the entire surface of the recording medium while a magnetic field was applied to repel the black particles and the temperature of the thermal head was set to 90° C. As a result, a checker pattern of black portions were printed on the light red backdrop. Thereafter, a black solid pattern was output while a magnetic field was applied to attract the black particles and the temperature of the thermal head was set to 72° C. As a result, the light red portion on the backdrop remained unchanged and the black portion of the checker pattern was changed to dark red, so that a checker pattern of light red and dark red was output.

As described above, the recording medium of the present disclosure is capable of displaying various colors by repeating printing while changing the temperature of a heating device. In addition, the image once printed can be sustained for a long period of time at room temperature without electricity consumption. By contrast, when no thermoreversible gelling agent was contained or the cells having different colors have the same sol transition temperatures and/or gel transfer temperatures, only two colors can be displayed, meaning that the present disclosure was not satisfied.

### Example 14

A recording medium was manufactured in the same manner as in Example 5 to prepare a roll screen type image recording set illustrated in FIG. 26. A flexible sheet was used as screen and a hole was made on the flexible sheet at a portion where the flexible sheet was attached to the recording medium to form an electrically connected portion. Thereafter, the recording medium was attached to the flexible sheet. To the rear side of the flexible sheet was attached an elecroconductive tape. The electroconductive substrate formed on the rear side of the recording medium was electrically connected to the electroconductive tape attached to the rear side of the flexible sheet through this electrically connected portion. A long pipe was fixed on the upper end of the thus-obtained flexible sheet. Gears were attached to both ends of the long pipe in order to roll up and release the flexible sheet at a constant speed by an electric motor.

In addition, a long pipe was attached to the lower end of the flexible sheet to prevent the flexible sheet from twisting. A heating device and an electric field application device were provided around the roll-up portion of the flexible sheet. A line thermal head serving as heating device and an electroconductive brush serving as an electric field application device were provided to the side of the flexible sheet on which the recording medium was provided to bring the electroconductive brush into contact with the electrode formed on the surface of the recording medium.

On the rear side of the flexible sheet, an electroconductive platen roller serving as electric field application device was arranged at the position facing the thermal head. The electroconductive platen roller was brought into contact with the electroconductive tape.

The electroconductive brush and the electroconductive platen roller were set in order to be arbitrarily electrically connected to a power source or grounded to make it possible to apply a desired bias thereto. In addition, the speed of rolling up and releasing the flexible sheet was adjusted by meeting the speed of the electroconductive platen roller and that of the electric motor.

The thus-manufactured flexible screen type image recording set was used to conduct a print test.

The entire surface of the image recording area of the recording medium was heated by the heating device set at 90° C. and a bias of +60 V was applied to the image recording layer of the recording medium by the electric field application device while rolling up the flexible sheet. Thereafter, when the flexible sheet was complete with rolling-up and thereafter released, the entire surface of the recording medium was confirmed to be reversed to white, meaning that the image was erased.

While rolling up the flexible sheet again, a checker pattern was output by the heating device set at 90° C. At the same time, a bias of −60 V was applied to the image recording layer of the recording medium by the electric field application device. There was no change to the non-heated area of the recording medium when the sheet was rolled up. Only the heated area was turned to blue. Accordingly, a checker pattern of blue on the background of white were printed. While rolling up the flexible sheet again, a solid pattern was output by the heating device set at 65° C. At the same time, a bias of +60 V was applied to the image recording layer of the recording medium by the electric field application device. When the sheet was released, the checker pattern changed to light red violet on the background of white. While rolling up the flexible sheet again, a solid pattern was output on the entire surface thereof by the heating device set at 65° C. At the same time, a bias of −60 V was applied to the image recording layer of the recording medium by the electric field application device. While the sheet was released, the background portion of white was turned to aqua and the light red violet portion of the checker pattern was changed to blue to form a checker pattern of aqua and blue was output.

As described above, in the image recording set of the present disclosure, the recording medium and the image recording device can be integrated. When a flexible sheet to which a recording medium is provided and if no thermoreversible gelling agent is contained, static is generated by the contact or friction of the recording medium with the flexible sheet, resulting in image disturbance in some cases. However, since the recording medium of the present disclosure was gelated to suppress the moving of particles, images are not disturbed by generated static. In addition, if magnetophoretic particles are used in a similar way, it is possible to avoid the influence of the magnetic field outside, so that the stability of images is excellent. In addition, since multiple colors are displayed, the image recording set of the present disclosure can be used as a sinage.

According to the present disclosure, a recording medium is provided which can display monochrome images or three or more color images and have high levels of image retention.

Having now fully described embodiments of the present invention, it will be apparent to one of ordinary skill in the art that many changes and modifications can be made thereto without departing from the spirit and scope of embodiments of the invention as set forth herein.

What is claimed is:

1. A recording medium comprising:
a first substrate;
a second substrate; and
an image recording layer with insulating properties, provided between the first substrate and the second substrate, the image recording layer comprising cells each encapsulating at least one of electrophoretic particles or magnetophoretic particles having two or more colors, a dispersion medium, and a thermoreversible gelling agent,
wherein at least one of sol transition temperature or gel transition temperature of the dispersion medium in each cell is different depending on a combination of the two or more colors of the at least one of the electrophoretic particles or magnetophoretic particles in each cell.

2. The recording medium according to claim 1, wherein a kind of at least one of the thermoreversible gelling agent or the dispersion medium contained in each cell depends on the two or more colors of at least one of the electrophoretic particles or the magnetophoretic particles.

3. The recording medium according to claim 1, wherein the first substrate or the second substrate is electroconductive.

4. The recording medium according to claim 1, further comprising an electroconductive layer provided between the first substrate and the image recording layer or between the second substrate and the image recording layer, and an electrode on an exterior of the recording medium, wherein the electroconductive layer and the electrode are electrically connected.

5. The recording medium according to claim 1, further comprising a first electric conductive layer between the first substrate and the image recording layer and a first electrode on an exterior of the recording medium, wherein the second substrate is electroconductive, wherein the first electroconductive layer and the first electrode are electrically connected.

6. The recording medium according to claim 1, further comprising a first electroconductive layer between the first substrate and the image recording layer, a second electroconductive layer between the second substrate and the image recording layer, and a first electrode and a second electrode on exteriors of the recording medium, wherein the first electroconductive layer and the first electrode are electrically connected, wherein the second electroconductive layer and the second electrode are electrically connected.

7. A recording medium comprising:
a first substrate;
a second substrate; and
an image recording layer with insulating properties, provided between the first substrate and the second substrate, the image recording layer comprising cells each encapsulating at least one of electrophoretic particles or magnetophoretic particles, a colorant, a dispersion medium having a color by the colorant, and a thermoreversible gelling agent,
wherein the color by the colorant is different from a color of at least one of electrophoretic particles or magnetophoretic particles,
wherein at least one of sol transition temperature or gel transition temperature of the dispersion medium in each cell is different depending on the color by the colorant.

8. The recording medium according to claim 7, wherein a kind of at least one of the thermoreversible gelling agent or the dispersion medium contained in each cell depends on the color by colorant of the dispersion medium.

9. The recording medium according to claim 2, wherein the first substrate or the second substrate is electroconductive.

10. The recording medium according to claim 7, further comprising an electroconductive layer provided between the first substrate and the image recording layer or between the second substrate and the image recording layer; and an electrode on an exterior of the recording medium, wherein the electroconductive layer and the electrode are electrically connected.

11. The recording medium according to claim 7, further comprising: a first electric conductive layer between the first substrate and the image recording layer; and a first electrode on an exterior of the recording medium, wherein the second substrate is electroconductive,
wherein the first electroconductive layer and the first electrode are electrically connected.

12. The recording medium according to claim 7,
further comprising a first electroconductive layer between the first substrate and the image recording layer,
further comprising a second electroconductive layer between the second substrate and the image recording layer,
further comprising a first electrode and a second electrode at exteriors of the recording medium,
wherein the first electroconductive layer and the first electrode are electrically connected,
wherein the second electroconductive layer and the second electrode are electrically connected.

13. An image recording set comprising:
the recording medium of claim 1; and
an image recording device to record an image in the recording medium, the image recording device comprising a heating device to heat the image recording layer in the recording medium and at least one of an electric field application device or a magnetic field application device to generate at least one of an electric field or a magnetic field in the image recording layer.

14. The image recording set according to claim 13, wherein the heating device is a thermal head.

15. The image recording set according to claim 13, further comprising an image erasing device to erase the image recorded in the recording medium by applying heat and at least one of an electric field or a magnetic field to the recording medium.

16. An image recording set comprising:
the recording medium of claim 2; and
an image recording device to record images in the recording medium, the image recording device comprising a heating device to heat the image recording layer in the recording medium and at least one of an electric field application device or a magnetic field application device to generate at least one of an electric field or a magnetic field in the image recording layer.

17. The image recording set according to claim 18, wherein the healing device is a thermal head.

18. The image recording set according to claim 18, further comprising an image erasing device to erase the image recorded in the recording medium by applying heat and at least one of an electric field or a magnetic field to the recording medium.
